(19) United States
(12) Patent Application Publication
(10) Pub. No.: US 2006/0020526 A1
(43) Pub. Date: Jan. 26, 2006

(54) Investment portfolio analysis system

(76) Inventor: Victor Viner, Northfield, IL (US)

Correspondence Address: CLIFFORD CHANCE US LLP, 31 WEST 52ND STREET, NEW YORK, NY, 10019-6131, US

(21) Appl. No.: 10/505,298

(22) PCT Filed: Feb. 27, 2003
(86) PCT No.: PCT/US03/05983

§ 371 Date: Jul. 18, 2005

Related U.S. Application Data
(60) Provisional application No. 60/360,206, filed on Feb. 28, 2002.
(60) Provisional application No. 60/361,191, filed on Feb. 28, 2002.

(51) Int. Cl. G06Q 40/00

(52) U.S. Cl. 705/35

(57) ABSTRACT

An investment portfolio management system enables computation of hedging strategies (each including one or more hedging transactions) and presentation of the strategies to the investor. Each hedging strategy takes into consideration tax impact information that is sparticularized to the individual investor. Investor portfolio data identifying assets owned by an investor and tax status information associated with the investor can be stored at a server that is accessible by a web browser. Software at the server enables computing of the hedging strategies based on an analysis of an investor's investment portfolio. The portfolio analysis includes an analysis of at least a first one of the assets identified by the investor portfolio data and a tax impact analysis to determine gain and loss and tax impact data associated with hedging transactions. The determined gain, loss and tax impact data can be determined based on the investor's particular tax status information.

This application claims priority from U.S. Provisional Applications 60/360,206 and 60/361,191, both filed Feb. 28,2002.

### BACKGROUND

Investors have a market level, i.e., a stock price between the highs and lows, where they feel comfortable. The job of an investment adviser is to match the investor's comfort level to market conditions and the investments in their portfolio. To do so, investment advisers need to manage gains and losses in the investor's account. This can be done through the use of portfolio management strategies such as hedging. To effectively develop portfolio management strategies, the investment adviser (and, in some cases, the investor himself or herself) needs to be able to take into account a variety of factors particular to the investor. For example, the investor's acceptable risk level, composition of the investor's portfolio, tax treatments applicable to various investments, and other financial information particular to the investor should be considered. Automated tools to simplify the process of analyzing each investor's unique financial characteristics and investment goals are desired.

### SUMMARY

In general, in one aspect, the invention features a computer-implemented system and method for managing an investment portfolio. The system enables computation of hedging strategies (each including one or more hedging transactions) and presentation of the strategies to the investor. Each hedging strategy takes into consideration tax impact information that is particularized to the individual investor. Investor portfolio data identifying assets owned by an investor and tax status information associated with the investor can be stored at a server that is accessible by a web browser. Software at the server enables computing of the hedging strategies based on an analysis of an investor's investment portfolio. The portfolio analysis includes an analysis of at least a first one of the assets identified by the investor portfolio data and a tax impact analysis to determine gain and loss and tax impact data associated with hedging transactions. The determined gain, loss and tax impact data can be determined based on the investor's particular tax status information.

Implementations may include one or more of the following features. Hedging strategies can be determined based on risk preferences associated with the investor, on market data (e.g., current and historic pricing and volatility) associated with the assets identified in the stored investor portfolio data, and on a user-specified timeframe and user specified upside and downside probabilities (i.e., probabilities that an asset price will be a predetermined price at a predetermined time). Risk preferences can be specified by data enabling automated selection from among a group of hedging strategies having different risk profiles, said strategies including both protective and yield enhancing strategies (among others). Portfolio analysis can include computing a position value, a realized gain/loss, an unrealized gain/loss, current taxes, future taxes, net position value, shares to sell for settlement, net shares, an unused realized loss and application of tax straddle rule and constructive sales rules compliant with the Taxpayer Relief Act of 1997. These computations can be performed for each of a group of price probabilities associated with an asset. Tax status information includes, e.g., total income information.

The portfolio analysis may include predicting asset price movement using a Monte Carlo simulation. Results may be presented in the graphical form. For example, a results graph can include a long stock position showing return of an investment in an asset versus price of the asset together with an option strategy overlay. The option strategy overlay may include gain and loss areas plotted using differing display characteristic and an option strategy outperformance range and a long stock outperformance range. The analysis can include analysis of multiple ones of the investor's assets and a comparative display of the analysis of multiple assets may be presented.

### DESCRIPTION OF THE DRAWINGS

FIG. 1 is a system architecture diagram.

FIG. 2 is a software architecture diagram.

FIG. 3 is a logical data flow diagram.

FIG. 4 shows interrelationships of data analysis processes implemented by the system.

FIG. 5 i s a table comparing protection strategies.

FIG. 6 is a table showing strategy performance information.

FIG. 7 through FIG. 27 show input and output data screens.

### DETAILED DESCRIPTION OF THE INVENTION

An investment portfolio management system, known herein by the product name “Nova,” can provide investment portfolio management services to users including portfolio tracking, risk management, and analytical analysis to enable volatility management of stocks. These analytical capabilities include the ability to customize investment strategies by taking into consideration tax effects applicable to the each user's unique portfolio and tax status. Implementations of the Nova system may also provide numerous other features, e.g., dynamically updating and comparing different investment strategies based on changing market conditions. Comparisons and analysis may be automatically formulated into a pitch book providing a comprehensive view of different investment strategies such that the view of those strategies is customized for a particular investor.

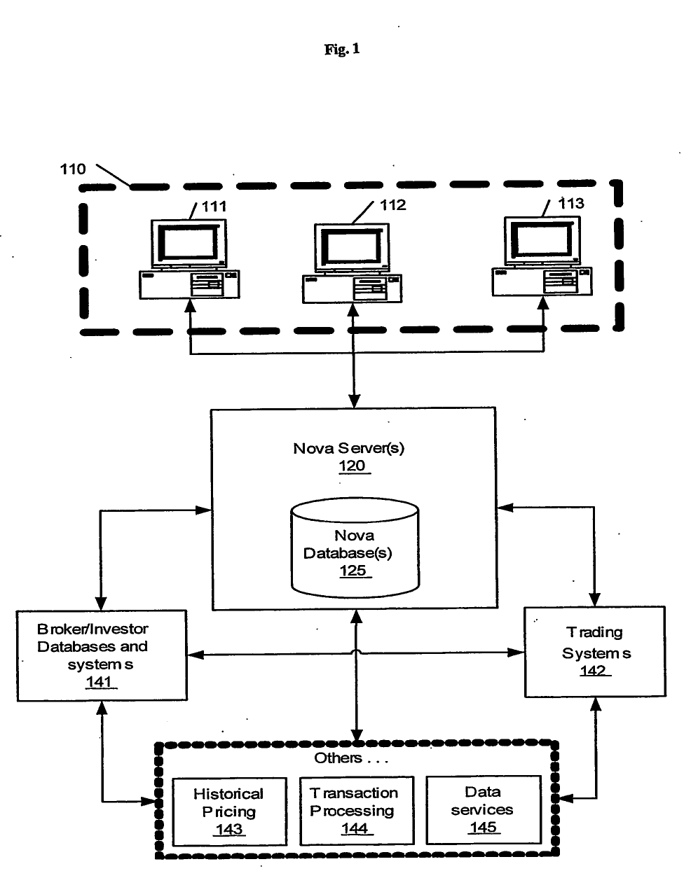

Referring to FIG. 1, the Nova system can be implemented using a web-technology based, application service provider (ASP) model computer system 100. The system 100 can interact with data providers, investment advisors, investors, and other parties. The system 100 includes a server 120 that can provide hypertext markup language (HTML) pages and forms to users at terminals 111-113. The data exchanged between the server 120 and terminals 110 can be used to display service interfaces to the users and to collect data from the users. Other types of data, such as Java(™) applets, executable software code, and multimedia files can also be exchanged between the server 120 and user terminals 110. The server 120 may also interface, directly and/or indirectly, with a number of other systems 141-144. The other systems can include user databases and systems 141, trading systems 142, transaction processing systems 144 and data services 145.

The Nova system 100 can provide services to manage investor portfolios. These services can include calculating portfolio values, tax implications of different investment strategies, and performing risk analysis.

The Nova server 120 includes a database 125 that stores investor profiles. The investor profiles include data identifying users. The database 125 also includes other data used for investment management. Typically, an investor's profile will include data received during an enrollment process, as well as data received and/or generated by the Nova system at other times.

Investor profile data can be received at the Nova server 120 using a web page interface (i.e., a hypertext markup language (HTML) form transmitted over a network using the hypertext transfer protocol (HTTP)). Transmission of the form to the user's computer and of collected data back to the system 120 can be achieved using hypertext transfer protocol (HTTP) and/or other networking protocol. The following are examples of investor profile data that can be collected from a user or other informational sources: (i) user name/address/city/state/zip/and taxpayer id number; (ii) investor positions, including the identification of asset (e.g., stocks and options) held by the investor, quantities, holding periods, etc.); (iii) investor risk preferences and investment goals (e.g., protection or yield enhancement). The investor profile data can be stored in the database 125 along with other investor-specific, and non-investor specific data (e.g., historical pricing and volatility data). Additional data collected by the system includes data items shown in tables and figures herein.

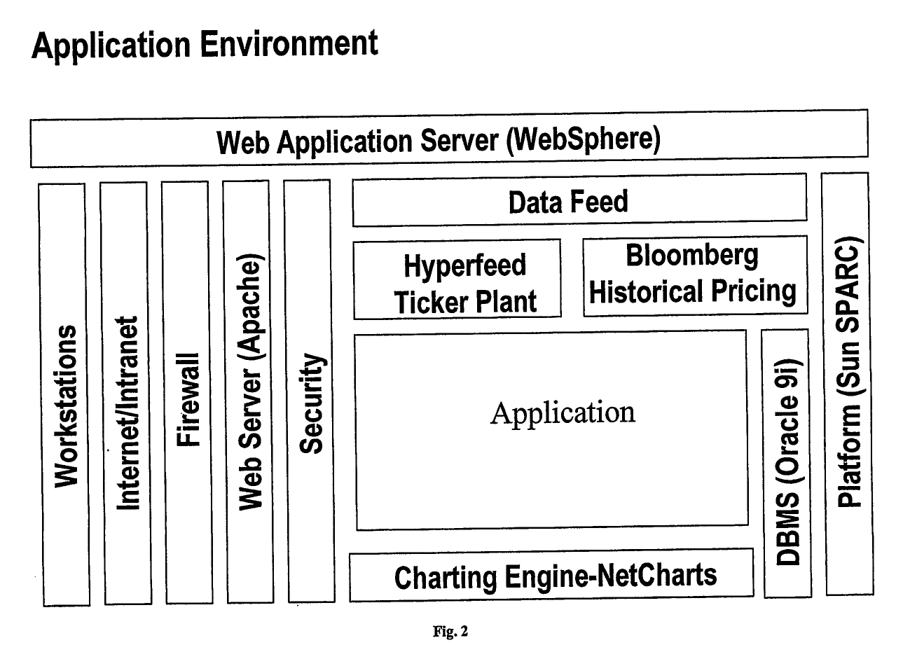

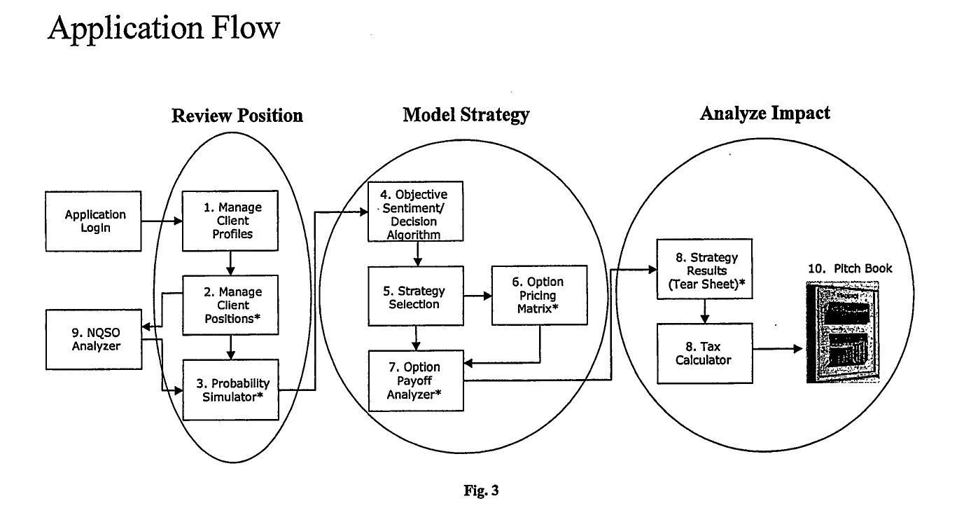

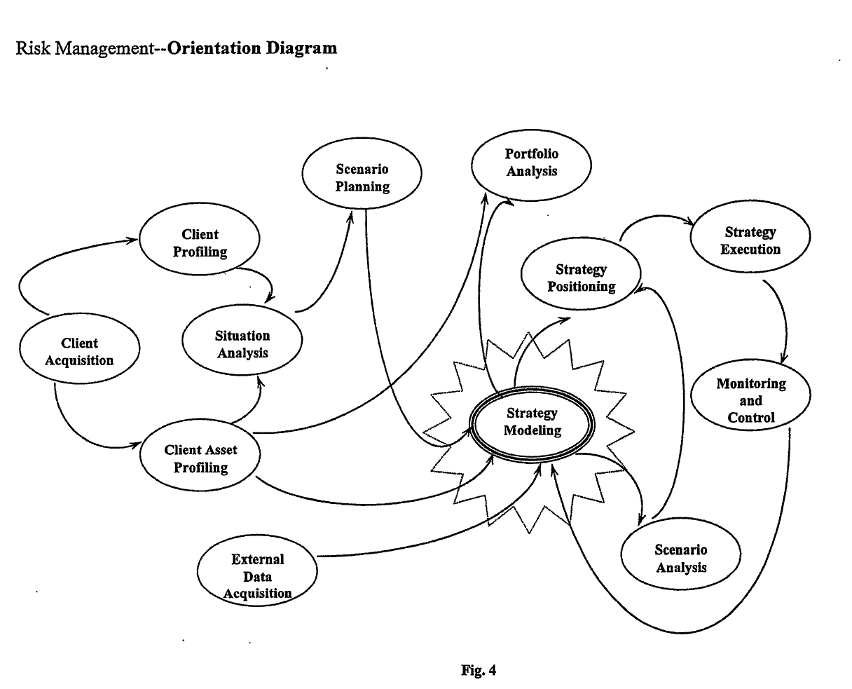

The Nova system processes the investor profile information and data about proposed transactions to determine payoff probabilities, to evaluate risk, and to determine strategies to hedge an investor's portfolio. Implementations may support a number of different hedging strategies including cashless collars, credit collars, put spread collars, prepaid variable forwards, participating collars, call spread collars, protective puts, put spreads, call writes, bull butterfly, and bear butterfly. Different ones of these strategies may be selected by the investor depending on the investor's particular mix of assets and investing strategies. FIG. 2 through FIG. 4 show additional details of the Nova system hardware environment and application processing functions of the Nova system.

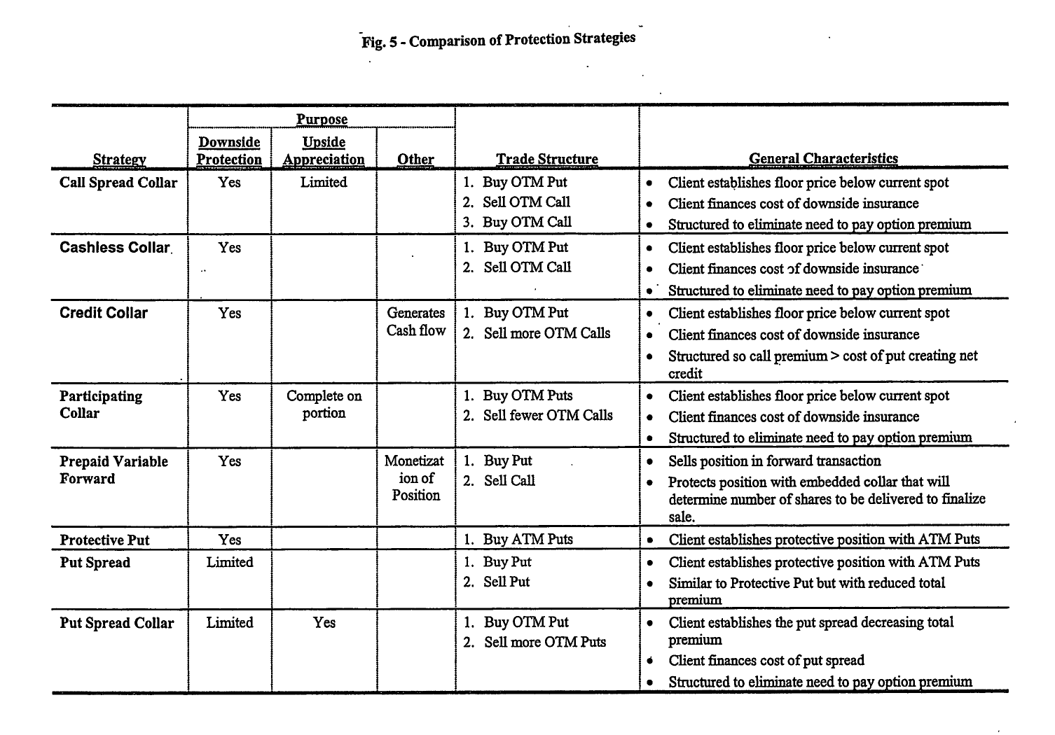

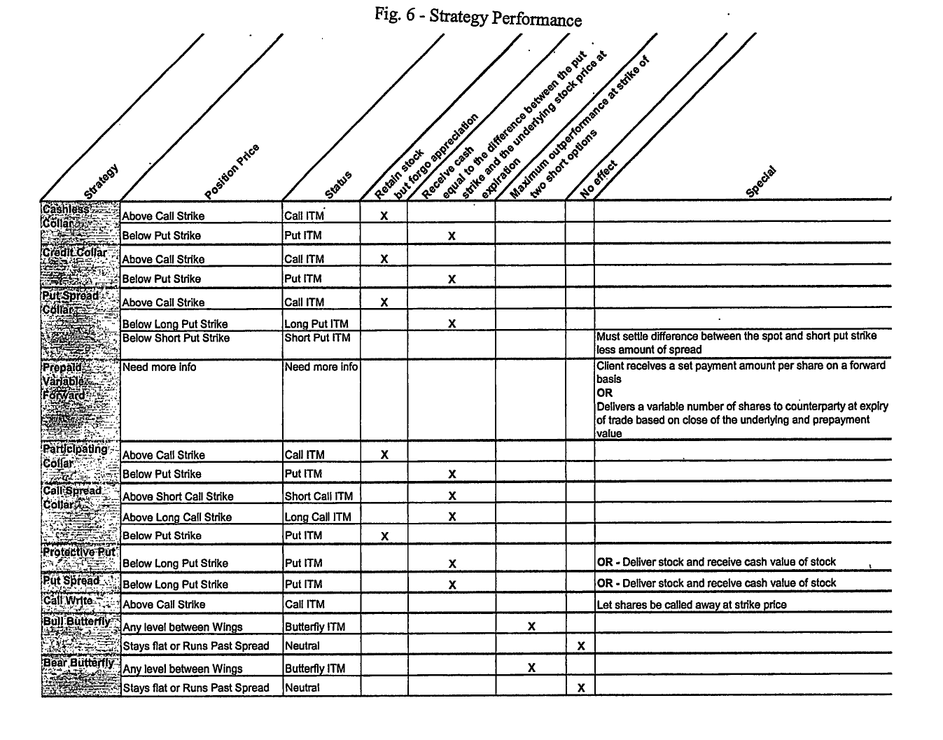

Generally speaking, these strategies can be classified as protection or as yield enhancement strategies. Example protection strategies are listed in FIG. 5 and yield enhancement strategies are listed in FIG. 6.

Selection of strategies, and determination of specific hedging transactions, can be based on the investor's tax status. In the disclosure that follows, general performance characteristics of the aforementioned hedging strategies are described along with the procedures used by the Nova system to help identify suitable strategies and to determine appropriate tax treatment and calculations. The table shown in FIG. 6 provides an overview of the strategies and a more detailed description follows. These strategies and applicable Nova system analysis capabilities will now be described in more detail.

### Call Spread Collar

Overview. A Call Spread Collar is documented and structured as an over-the-counter (“OTC”) option contract. A call spread collar is an offsetting position of the underlying stock structured to substantially diminished risk of loss of the stock position. As a result IRC Section 1092 straddle rules apply and the holding period of the hedged stock terminates when the option collar was entered. No current deduction for losses is allowable to the extent of there is unrecognized gain at the end of the taxable year in “offsetting positions” to the loss position.

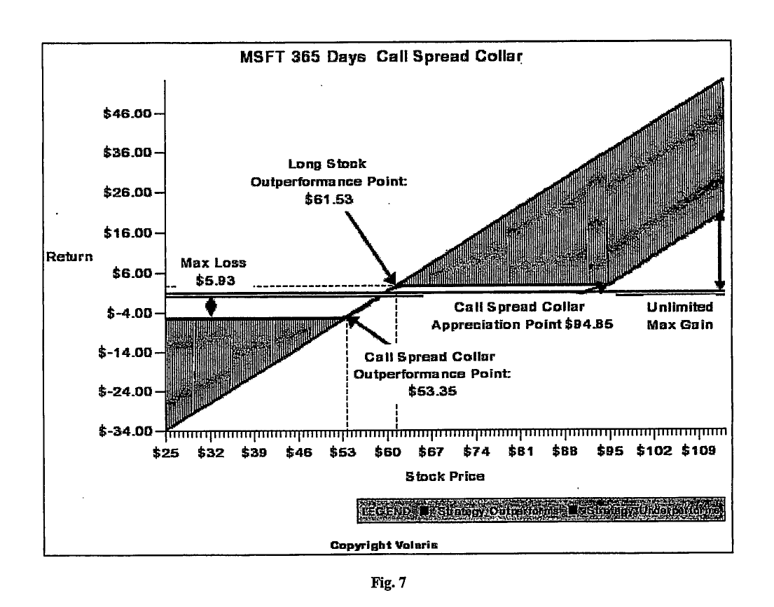

FIG. 7 shows, generally, a graphed output produced by the Nova system based on analysis of a call spread collar transaction (in this case, a 365 day call spread on a security identified by the symbol “MSFT”). The graph of FIG. 7 includes a long stock position indicator shown as a line running from the lower left-hand origin of the graph to the upper right-hand portion. This long stock position indicator shows the return on an asset (e.g., on a stock) versus the asset price (i.e., the stock price) at the time of sale of the asset. In addition to the long stock position indicator, the graph includes option strategy performance information. This information is shown as patterned, shaded, or colored areas overlaid on the graph and indicating prices at which the hedged asset will outperform a unhedged long position in the assets and, corresponding, points at which the hedged asset will underperform an unhedged long position in the asset. Preferably the option strategy outperformance range is shaded in green and the long stock outperformance range is shaded in red. Key price points shown in the graph of FIG. 7 include the following:
Spot Price. The current price of the stock.
Max Loss. The maximum dollar loss per share that can be sustained by the long stock with the collar strategy in place.
Long Stock Outperformance Point. The stock price at which the short call component of the collar will limit the upside potential of the stock position. Above this price all gains of the long stock position will be foregone.
Max Gain. The maximum dollar gain per share that the long stock can appreciate with the strategy in place.
Breakeven. The point at which the position has no gain or loss.
Yield Enhancement. Equal to the amount of premium received per share.
Call Spread Collar Ouperformance Point. The stock price at which the protective attributes of the collar take effect. Below this price the long stock position is protected.
Call Spread Collar Apreciation Point. The stock price at which the long call component of the collar will resume appreciation of the collar and stock position.

The analysis performed by the Nova system is implemented by a system that processes software-based rules to effect the following requirements:

Equity Settlement. The IRC Section 1092 straddle rules have no impact on the strategy, because at the end of the collar transaction, if there is gain or loss from the collar transaction, the individual always delivery underlying stock against the collar. The gain or loss will be taxed at long-term or short-term depends on the holding period of the underlying stock when the collar transaction was entered.

Cash Settlement. The IRC Section 1092 straddle rules apply if there is loss realized on the collar and there is unrecognized gain on the underlying stock. No current deduction for loss is allowable to the extent of the unrecognized gain on the underlying stock. Gain on the collar is short-term gain, loss is long-term or short-term depends on the holding period of the underlying stock when the collar transaction was entered. In this case, there is loss realized on the collar, Nova also allows individual to sell stock to generate cash to pay for amounts due to the counterparty.

The rules implemented by the system 100 can also be used to advise an investor regarding particular investment strategies. For example, based on an investor's unique profile data, the system 100 may advise regarding particular “pros” and “cons” of the system. Example “pros” and “cons” for a call spread collar strategy are shown in Table 1. As disclosed herein, the system 100 can include rules to provide other “pros” and “cons” advice for other strategies. Other example “pros” and “cons” descriptions accompany other investment strategy descriptions provided herein.

TABLE 1
Pros and Cons of a Call Spread Collar

| Pros | Cons |
|---|---|
| Structured to eliminate need to pay option | Client relinquishes upside price appreciation |
| premium. | between the short call strike and the long call |
| The investor has full participation up to the call | strike and has downside exposure to the price |
| strike and full protection below the put strike and | level of the put. |
| full participation above the long call strike. | Client must post underlying shares as |
| Collar defers the taxable event that would result | collateral to establish the position. |
| from the sale of shares. | Careful attention to the constructive sale |
| Client typically retains ownership, dividends, and | provision of the Taxpayer Relief Act of 1997 |
| voting rights of the underlying equity. | is recommended. |
| Client can monetize the position by borrowing | Affiliates, Insiders, and Control Persons may |
| against a percentage of the put strike price. | have to report transactions on Form 4. |
| Client can post the protected value of the position | |
| (stock and put option) as collateral for a loan. The | |
| terms of the loan are flexible and are subject to | |
| Regulation T for purpose loans (for investments in | |
| securities). | |

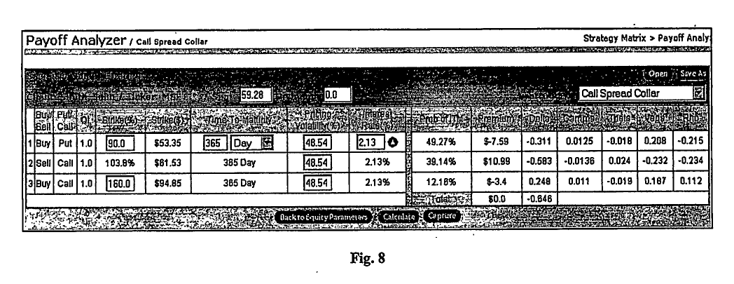

Referring to FIG. 8, the Nova user interface allows the input of the long put strike (the level of protection) and the long call strike (the price at which the appreciation resumes). In some implementations, it may be possible to select long put and long calls strikes that cannot be solved for a short call (i.e., the cost of the long options is too great for an out of the money short call option to cover). In these instances, the application displays a message stating that the long call strike selected is too low and that the user needs to select a higher long call strike.

Tax implications of a call spread collar are shown in Table 2. The Nova system includes software processes to implement tax analysis based on the following tax requirements.

TABLE 2
Tax Implications of Call Spread Collar Strategy

| Position | | |
|---|---|---|
| Finish | Equity Settlement | Cash Settlement |
| Between | Contract expires. | No taxable event, same underlying positions |
| Long Put | Position value equals to stock price. | going forward. |
| and Short | No taxable event, same underlying positions | Deferred tax (or benefit if cost basis is higher |
| Call | going forward. | than stock price) is stock price minus cost |
| | Deferred tax (or benefit if cost basis is | basis calculated using long or short-term tax |
| | higher than stock price) is stock price minus | rate depends on the underlying stock holding |
| | cost basis calculated using long or short- | period when the contract was entered. |
| | term tax rate depends on the underlying | |
| | stock holding period when the contract was | |
| | entered. | |
| Between | Position value equals to short call strike. | Deferred straddle loss resulted from the |
| Short Call | Stocks get assigned and delivered against | difference between short call strike and stock |
| and Long | short call. | price is long or short term depends on the |
| Call | Capital gain equals to short call strike | underlying stock holding period when the |
| | minus cost basis (or loss if cost basis is | call spread contract was entered. |
| | higher than short call strike) is long or short | Deferred tax (or benefit if cost basis is higher |
| | term depending on the underlying stock | than stock price) equals to stock price minus |
| | holding period when the call spread contract | cost basis is calculated using long or short- |
| | was entered. | term tax rate depends on the underlying stock |
| | | holding period when the contract was |
| | | entered. |
| | | Model will calculate # of shares need to be |
| | | sold that could generate after tax cash to pay |
| | | to the counter party. |
| | | Model will not offset capital gain, if any, |
| | | from the sale of underlying position with |
| | | straddle losses created by the option, to the |
| | | extend there is remaining underlying stock |
| | | and total loss is not exceeding unrecognized |
| | | gain. |
| Below Long | Position value equals to long put strike. | Short-term capital gain resulted from the |
| Put | Exercise the call spread collar, stocks get | difference between long put strike and stock |
| | delivered against long put. | price. |
| | Capital gain (or loss if cost basis is higher | Deferred tax (or benefit if cost basis is higher |
| | than long put strike) equal to long put strike | than stock price) equals to stock price minus |
| | minus cost basis is long or short depends on | cost basis is calculated using long or short- |
| | the underlying stock holding period when | term tax rate depends on the underlying stock |
| | the call spread contract was entered. | holding period when the contract was |
| | | entered. |
| Above | Position value equals to stock price | Deferred straddle loss equals to long call |
| Long Call | minus long call strike plus short call | strike and short call strike is long or |
| | strike. | short term depends on the underlying |
| | No change in the underlying position. | stock holding period when the call |
| | Deferred straddle loss resulted from the | spread contract was entered. |
| | difference between short call strike and | Deferred tax (or benefit if cost basis is |
| | long call strike is long or short term | higher than stock price) equals to stock |
| | depends on the underlying stock | price minus cost basis is calculated using |
| | holding period when the call spread | long or short-term tax rate depends on |
| | contract was entered. | the underlying stock holding period |
| | Deferred tax (or benefit if cost basis is | when the contract was entered. |
| | higher than stock price) equal to stock | Model will calculate # of shares need to |
| | price minus cost basis is calculated | be sold that could generate after tax cash |
| | using long or short-term tax rate | to pay to the counterparty. |
| | depends on the underlying stock | Model will not offset capital gain, if any, |
| | holding period when the contract was | from the sale of underlying position with |
| | entered. | straddle losses created by the option, to |
| | | the extend there is remaining underlying |
| | | stock and total loss is not exceeding |
| | | unrecognized gain. |

### Cashless Collar

Overview. A cashless collar is documented and structured as one over-the-counter (“OTC”) option contract. A cashless collar is an offsetting position of the underlying stock that substantially diminished risk of loss of the stock position. As a result the IRC Section 1092 straddle rules apply, and the holding period of the stock terminates when collar was entered. No current deduction for losses is allowable to the extent of there is unrecognized gain at the end of the taxable year in “offsetting positions” to the loss position.

Equity Settlement. The IRC Section 1092 straddle rules have no impact on the strategy, because at the end of cashless collar transaction, if there is gain or loss from the collar transaction, the individual always delivery underlying stock against cashless collar. The gain or loss will be taxed at long-term or short-term depends on the holding period of the underlying stock when the collar transaction was entered.

Cash Settlement. The IRC Section 1092 straddle rules apply if there is loss realized on the cashless collar and there is unrecognized gain on the underlying stock. No current deduction for loss is allowable to the extent of the unrecognized gain on the underlying stock. Gain on the collar is short-term gain, loss is long-term or short-term depends on the holding period of the underlying stock when collar transaction was entered. In the case, there is loss realized on the collar, Nova also allows individual to sell stock to generate cash to pay for amount due to the counterparty. The software calculates number of shares needed to sell to generate after tax cash to pay to counterparty.

TABLE 3
Pros and Cons of a Cashless Collar

| Pros | Cons |
|---|---|
| Structured to eliminate need to pay option premium. | Client relinquishes upside price appreciation |
| The investor has full participation up to the call strike and | above call strike and has downside exposure |
| full protection below the put strike and full participation | to the price level of the put. |
| below the put strike. | Client must post underlying shares as |
| Collar defers the taxable event that would result from the | collateral to establish the position. |
| sale of shares. | Careful attention to the constructive sale |
| Client typically retains ownership, dividends, and voting | provision of the Taxpayer Relief Act of 1997 |
| rights of the underlying equity. | is recommended. |
| Client can monetize the position by borrowing against a | Affiliates, Insiders, and Control Persons may |
| percentage of the put strike price. | have to report transactions on Form 4. |
| Client can post the protected value of the position (stock | |
| and put option) as collateral for a loan. The terms of the | |
| loan are flexible and are subject to Regulation T for | |
| purpose loans (for investments in securities). | |

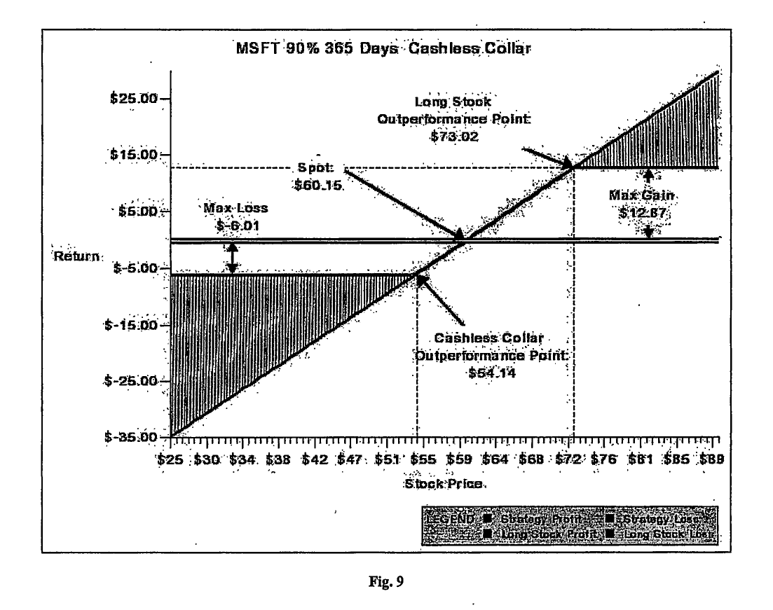

FIG. 9 shows a graphed output produced by the Nova system based on analysis of a cashless collar transaction. Many of the key pricing points shown in FIG. 9 are substantially identical to those of FIG. 7 and are not repeated here. Additional price analysis points not shown in FIG. 7 include the following:

Cashless Collar Outperformance Point. The stock price at which the protective attributes of the collar take effect. Below this price the long stock position is protected.

TABLE 4
Tax implications for a cashless collar.

| Position | | |
|---|---|---|
| Finish | Equity Settlement | Cash Settlement |
| Within | No taxable event, same underlying | No taxable event, same underlying positions |
| band | positions going forward. | going forward. |
| | | Deferred tax (or benefit if cost basis is higher than |
| | | stock) is calculated stock price minus cost basis |
| | | Long or short-term tax rate depending on the |
| | | underlying stock holding period when the collar |
| | | contract was entered. |
| Below | Exercise collar, stock is delivered | Short-term capital gain generated from the |
| band | against long put | difference between put strike and stock price. |
| | Capital gain (or loss if cost basis is | Same stock positions going forward, and deferred |
| | higher than put strike price) generated | tax formula. |
| | from the difference between put strike | |
| | and cost basis of the underlying stock. | |
| | Long or short term depending on the | |
| | underlying stock holding period when | |
| | the collar contract was entered. | |
| Above | Stock gets assigned, delivered against | Capital loss equal to stock price minus short call |
| band | short call. | strike |
| | Capital gain (or loss if cost basis is | Long-term depending on the underlying stock |
| | higher than call strike price) equal to | holding period when the collar contract was |
| | call strike price minus cost basis of the | entered, not recognizable in the current year to the |
| | underlying stock | extent there is unrecognized gain on the |
| | Long or short term tax rate depending | underlying stock |
| | on the underlying stock holding period | Model will calculate # of shares to be sold to |
| | when the collar contract was entered. | generate after tax cash to pay to the counter party. |
| | | Model will not offset capital gain, if any, from the |
| | | sale of underlying position with straddle losses |
| | | created by the option, to the extent there is |
| | | remaining underlying stock and total loss does not |
| | | exceed unrecognized gain. |

### Credit Collar

Overview. Credit collar is documented and structured as one over-the-counter (“OTC”) option contract. Net credit premium is received upon entering into the contract. Credit collar is an offsetting position of the underlying stock, substantially diminished risk of loss of the stock position, that makes the IRC Section 1092 straddle rules apply, the holding period of the stock terminates when option collar was entered. No current deduction for losses is allowable to the extent of there is unrecognized gain at the end of the taxable year in “offsetting positions” to the loss position.

Equity Settlement. The IRC Section 1092 straddle rules have no impact on the strategy, because at the end of credit collar transaction, if stock finishes outside of the collar spread, the individual always delivery underlying stock against the credit collar. The gain or loss will be taxed at long-term or short-term depends on the holding period of the underlying stock when the collar transaction was entered. Individual retains underlying stock, if stock finishes within the collar spread, the net premium received is short-term capital gain.

Cash Settlement. The IRC Section 1092 straddle rules apply if there is loss realized on the collar and there is unrecognized gain on the underlying stock. No current deduction for loss is allowable to the extent of the unrecognized gain on the underlying stock. Gain on the collar is short-term gain, loss is long-term or short-term depends on the holding period of the underlying stock when the collar transaction was entered. In the case, there is loss realized on the collar, Nova also allows individual to sell stock to generate cash to pay for amount due to the counterparty. The software calculates number of shares needed to sell to generate after tax cash to pay to counterparty.

TABLE 5
Pros and Cons of a Credit Collar

| Pros | Cons |
|---|---|
| The sale of the call generates excess cashflow that | Client relinquishes upside price appreciation |
| finances the price of the put and provides a credit | above call strike and has downside exposure to |
| thereby increasing the amount of protection to the | the price level of the put. |
| downside. | Client must post underlying shares as collateral |
| The investor has full participation up to the call strike | to establish the position. |
| and full protection below the put strike. | Careful attention to the constructive sale |
| Client typically retains ownership, dividends, and | provision of the Taxpayer Relief Act of 1997 is |
| voting rights of the underlying equity. | recommended. |
| Client can monetize the position by borrowing against | Affiliates, Insiders, and Control Persons may |
| a percentage of the put strike price. | have to report transactions on Form 4. |
| Client can post the protected value of the position | |
| (stock and put option) as collateral for a loan. The | |
| terms of the loan are flexible and are subject to | |
| Regulation T for purpose loans (for investments in | |
| securities). | |

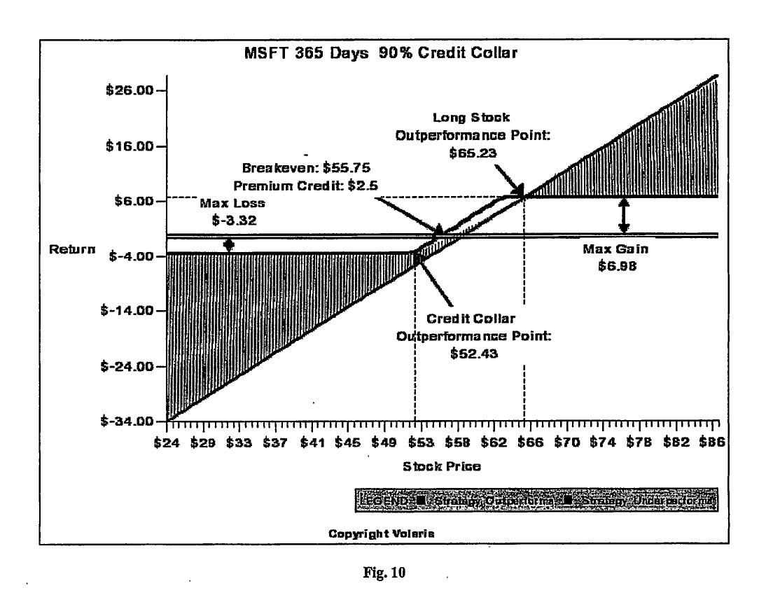

FIG. 10 shows, generally, a graphed output produced by the Nova system based on analysis of a credit collar transaction. Many of the key pricing points shown in FIG. 10 are substantially identical to those of FIG. 7 and are not repeated here. Additional price analysis points not shown in FIG. 7 include the following:
Credit Collar Outperformance Point is the stock price at which the protective attributes of the collar take effect. Below this price the long stock position is protected.

Breakeven details the point at which the position has no gain or loss. In the case of the Credit Collar, the Breakeven is less than the Spot by the amount of the premium received per share.

TABLE 6
Tax Implications of Credit Collar Strategy

| Position | | |
|---|---|---|
| Finish | Equity Settlement | Cash Settlement |
| Within | Position value equal to stock price | Same as Equity Settlement |
| band | plus credit premium. | |
| | Net credit premium taxed as short- | |
| | term gain. | |
| | No change on the underlying | |
| | position. | |
| | Deferred tax (or benefit if cost basis | |
| | is higher than stock price) is | |
| | calculated as stock price minus cost | |
| | basis | |
| | Long or short-term tax rate depending | |
| | on the underlying stock holding | |
| | period when the spread contract was | |
| | entered. | |
| Below | Position value equal to long put strike | Short-term capital gain equal to long put strike |
| band | plus credit premium. | minus stock price plus net credit. |
| | Exercise collar, stock is delivered | Deferred tax (or benefit if cost basis is higher |
| | against long put. | than stock price) is stock price minus cost |
| | Capital gain (or loss if put strike plus | basis. |
| | credit received is less than cost basis) | Long or short-term depends on the underlying |
| | equals to put strike minus cost basis | stock holding period when the spread contract |
| | plus net credit received. | was entered. |
| | Long or short-term tax rate depending | |
| | on the underlying stock holding | |
| | period when the spread contract was | |
| | entered. | |
| Above | Position value equal to short call | Straddle capital loss (or gain if stock price |
| band | strike plus credit premium. | plus credit received is less than call strike) |
| | Stocks get assigned, delivered against | equals to stock price minus short call strike |
| | short call. | minus credit premium received |
| | Capital gain (or loss if call strike plus | Not recognizable in the current year. |
| | credit received is less than cost basis) | Gain is always short-term, loss is long or |
| | equals to call strike minus cost basis | short-term depends on the holding period of |
| | plus net credit received | the underlying stock when credit collar |
| | Long or short depending on the | contract was entered. |
| | underlying stock holding period when | Model will calculate # of shares need to be |
| | the collar contract was entered. | sold that could generate after tax cash to pay |
| | | to the counter party. |
| | | Model will not offset capital gain, if any, from |
| | | the sale of underlying position with straddle |
| | | losses created by the option, to the extend |
| | | there is remaining underlying stock and total |
| | | loss is not exceeding unrecognized gain. |

### Participating Collar

Overview. A participating collar is documented and structured as one over-the-counter (“OTC”) option contract. Unlike a standard collar, which requires the individual to give up the benefit of appreciation above call strike price, by using call/put ratio, a participating collar allows the individual to participate in a portion of appreciation above call strike price. Participating collar is an offsetting position of the underlying stock, substantially diminished risk of loss of the stock position, that makes the IRC Section 1092 straddle rules apply, the holding period of the stock terminates when option collar was entered. No current deduction for losses is allowable to the extent of there is unrecognized gain at the end of the taxable year in “offsetting positions” to the loss position.

Equity Settlement. The IRC Section 1092 straddle rules have no impact on the strategy, because at the end of the collar transaction, if there is gain or loss from the collar transaction, the individual always delivery underlying stock against the collar. The gain or loss will be taxed at long-term or short-term depends on the holding period of the underlying stock when the collar transaction was entered.

Cash Settlement. The IRC Section 1092 straddle rules apply if there is loss realized on the participating collar and there is unrecognized gain on the underlying stock. No current deduction for loss is allowable to the extent of the unrecognized gain on the underlying stock. Gain on the collar is short-term gain, loss is long-term or short-term depends on the holding period of the underlying stock when the collar transaction was entered. In the case, there is loss realized on the collar, Nova also allows individual to sell stock to generate cash to pay for amount due to the counterparty. The software calculates number of shares needed to sell to generate after tax cash to pay to counterparty.

TABLE 7
Pros and Cons of Participating Collar Strategy

| Pros | Cons |
|---|---|
| Client has full participation up to the call strike, partial | Client relinquishes percentage of the upside |
| participation beyond the call strike, and full protection | price appreciation above the call strike and |
| below the put strike. | has downside exposure to the strike price of |
| Structured to eliminate need to pay option premium. | the put. |
| The collar defers the taxable event that would result | Strike price on the call option will be lower |
| from the sale of shares. | than in the traditional collar thereby capping a |
| Client typically retains ownership, dividends, and | portion of the position at a lower price. |
| voting rights of the underlying equity. | Client must post underlying shares as |
| | collateral for establishing the position. |
| | Careful attention to the constructive sale |
| | provision of the Taxpayer Relief Act of 1997 |
| | is recommended. |
| | Affiliates, Insiders, and Control Persons may |
| | have to report transactions on Form 4. |

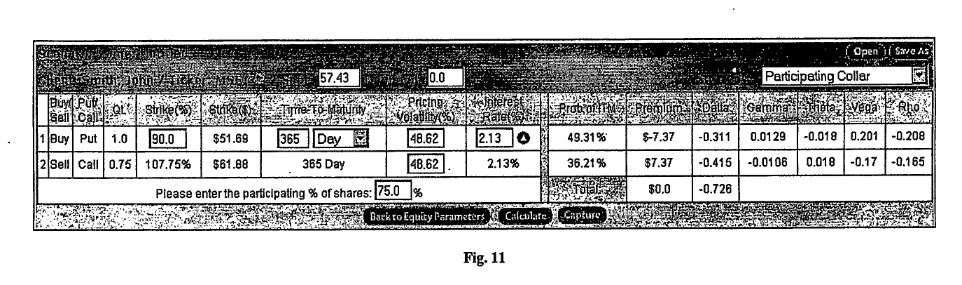

Data Entry Hints. Referring now to FIG. 11, the Nova user interface allows the input of the long put strike (the level of protection) and the long call strike (the price at which the appreciation resumes). In some implementations, it may be possible to select a participating percentage that is too high and cannot be solved for a participating call (i.e., the number of calls sold cannot cover the cost of the Long puts). In these instances, the application displays a message stating that the participating percentage selected is too high and that the user needs to select a lower participating percentage.

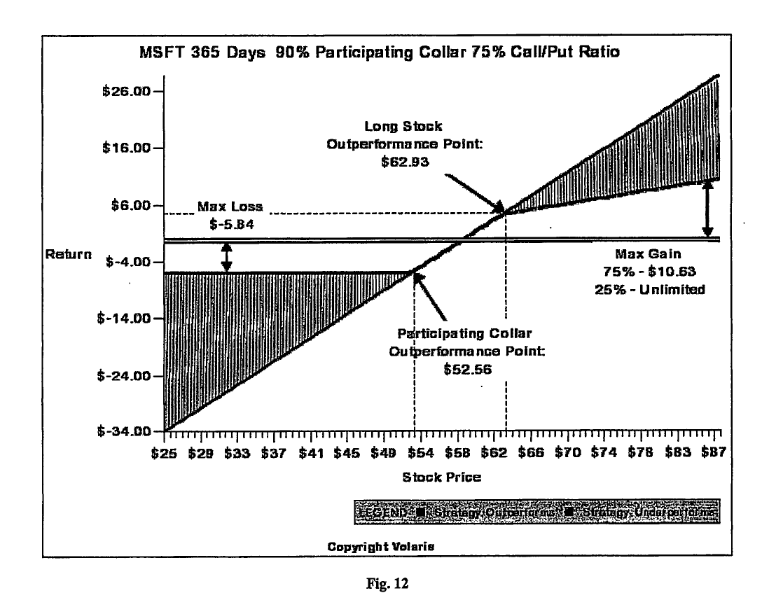

FIG. 12 shows a graphed output produced by the Nova system based on analysis of a prepaid variable forward transaction. Many of the key pricing points shown in FIG. 12 are substantially identical to those of FIG. 7 and are not repeated here. Additional price analysis points not shown in FIG. 7 include the following:
Cashless Collar Outperformance Point. The stock price at which the protective attributes of the collar take effect. Below this price the long stock position is protected.

Long Stock Outperformance Point. The stock price at which the short call component of the collar will limit the upside potential of the stock position. Above this price all gains of the long stock position will be foregone by the percentage of the underlying shares that are covered. The percentage of the underlying that is not covered will “participate” completely in the upside appreciation.

TABLE 8
Tax Implications for Participating Collar Transaction

| Position | | |
|---|---|---|
| Finish | Equity Settlement | Cash Settlement |
| Within | No taxable event, same underlying positions | No taxable event, same positions |
| band | going forward. | going forward. |
| | Deferred tax (or benefit if cost basis is higher than | |
| | stock) is calculated stock price minus cost basis | |
| | with long or short-term tax rate depending on the | |
| | underlying stock holding period when the collar | |
| | contract was entered. | |
| Below | Exercise collar, stock is delivered against long put | Short-term capital gain generated |
| band | Capital gain (or loss if cost basis is higher than put | from the difference between put |
| | strike price) generated from the difference | strike and stock price. |
| | between put strike and cost basis of the underlying | Same stock positions going |
| | stock. | forward.. |
| | Long or short term depending on the underlying | |
| | stock holding period when the collar contract was | |
| | entered. | |
| Above | Position value equal to 75% of short call strike | Capital loss equal to stock price |
| band | plus 25% of stock price. | minus short call strike |
| | 75% of Stock gets assigned, delivered against | Long-term not recognizable in the |
| | short call | current year. |
| | Capital gain (or loss if cost basis is higher than | Model will calculate # of shares to |
| | call strike price) equal to call strike price minus | be sold to generate after tax cash to |
| | cost basis of 75% of the underlying stock is long | pay to the counter party. |
| | or short term depending on the underlying stock | Assume prorate of capital gain can |
| | holding period when the collar contract was | be offset with the capital loss carried |
| | entered. | forward based on # of shares that |
| | Deferred tax (or benefit if cost basis is greater | need to be sold. |
| | than stock price) on the remaining 25% of | Net shares equal to total shares |
| | underlying position is stock price minus cost | minus # of shares sold. |
| | basis, calculated using long or short-term tax rate | |
| | depending on the underlying position's holding | |
| | period when the collar contract was entered. | |

### Prepaid Variable Forward

Overview. In a prepaid variable forward transaction, the individual receives a cash advance that represents a discounted forward sale price for the shares. Under the current tax law, a properly structured prepaid forward should not trigger a taxable event at the time of issuance. However, prepaid variable forward is an offsetting position of the underlying stock, substantially diminished risk of loss of the stock position, that makes the IRC Section 1092 straddle rules apply, the holding period of the stock terminates when forward contract was entered. The software assumes the forward contract is equity settled.

TABLE 9
Pros and Cons of Prepaid Variable Forward Strategy

| Pros | Cons |
|---|---|
| Client receives cash at the inception of the contract for a | Client foregoes upside price appreciation |
| future sale commitment. | above call strike. |
| Client has full participation up to the level of the cap. | Client has no ability to change the prepayment |
| Client's maximum obligation at maturity is delivery of the | amount during the transaction. |
| underlying shares. | Client must post underlying shares as |
| Use of the prepayment amount is not restricted by | collateral for establishing the position. |
| Regulation U or Regulation T. | Affiliates have Rule 144 reporting |
| Variable Forward may defer the taxable event until the | requirements at the trade inception. |
| maturity of the contract. | Affiliates may have to report transactions on |
| Client typically retains ownership, dividends, and voting | Form 4. |
| rights of the underlying equity until expiration. | |
| Expiration of the contract may not be considered a Section | |
| 16 purchase for affiliates. | |

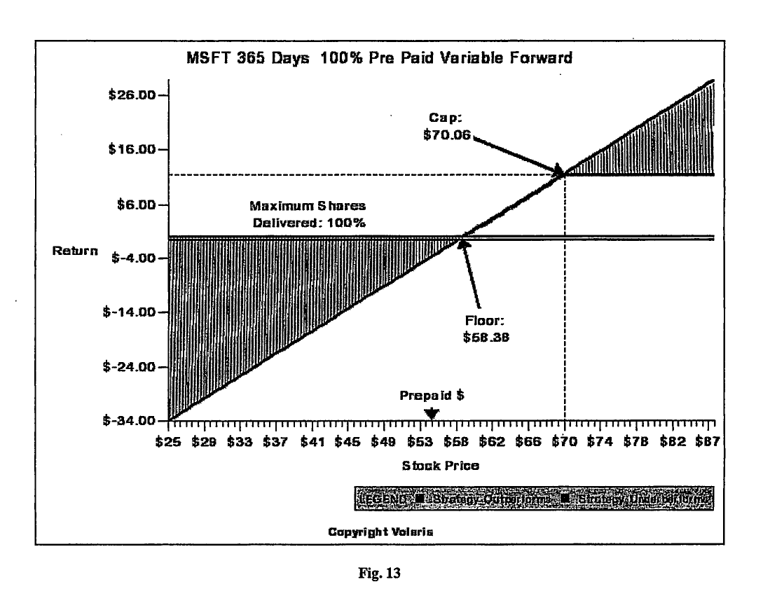

FIG. 13 shows, generally, a graphed output produced by the Nova system based on analysis of a prepaid variable forward transaction. Many of the key pricing points shown in FIG. 13 are substantially identical to those of FIG. 7 and are not repeated here. Additional price analysis points not shown in FIG. 7 include the following:
Cap. Similar to a short call in a collar, this is the price at which the upside appreciation of the shares is capped.
Floor. Similar to the long put in a collar, this is the price at which a minimum value of a position is guaranteed, and against which 100% of the shares sold will be delivered. Max Shares Delivered. Max Shares Delivered details the price at which 100% of the underlying position will be delivered.

Max Shares Value Retained. Max Share Value Retained details the percentage value of the underlying position, which will be retained at expiry of the position.

TABLE 10
Tax Implications for A Prepaid Variable Forward Strategy

| Position Finish | Equity Settlement | Cash Settlement |
|---|---|---|
| Between Cap | Partial shares sold. | Nova does not offer the |
| and Floor or | Capital gain or loss equals to shares delivered | possibility of cash settlement for |
| Above Cap | multiply by fair value minus cost basis. | the Prepaid Variable Forward. |
| | Long or short-term depends on whether the | |
| | underlying positions had more than one year holding | |
| | period before enter into the contract. | |
| | Deferred tax is calculated on the shares retained, it is | |
| | long or short-term depends on whether the underlying | |
| | positions had more than one year holding period | |
| | before enter into the contract. | |
| Below or At | 100% shares delivered against contract. | Nova does not offer the |
| Floor | Capital gain (or loss if cost of stock is greater than | possibility of cash settlement for |
| | prepayment received) equals to prepayment received | the Prepaid Variable Forward. |
| | minus cost basis. | |
| | Long or short-term depends on the holding period of | |
| | the underlying stock when the contract is entered. | |

### Protective Put

Overview. Protective put in Nova software only allows individual long out-of-money put on either equity settled listed market or cash settled over-the-counter (“OTC”) market. The long put contract is not entered on the same date as the individual purchasing the underlying stock, therefore, the “married put” straddle exceptions do not apply. The individual uses cash paid premium when entering the contract. Protective put is an offsetting position of the underlying stock, substantially diminished risk of loss of the stock position, that makes the IRC Section 1092 straddle rules apply, the holding period of the stock terminates when the option contract was entered.

Equity Settlement-Listed Market. The IRC Section 1092 straddle rules have no impact, if stock finishes under the put strike, the individual always delivery underlying stock against the put. The gain or loss will be taxed at long-term or short-term depends on the holding period of the underlying stock when the put transaction was entered. Individual retains underlying stock, if stock finishes at or above the put strike, because of straddle rules, to the extend there is unrecognized gain on the underlying stock, net premium paid will create future tax benefit at long-term or short-term depends on the holding period of the underlying stock when the put transaction was entered.

Cash Settlement-OTC Market. The IRC Section 1092 straddle rules apply if there is loss realized on the put and there is unrecognized gain on the underlying stock. No current deduction for loss is allowable to the extent of the unrecognized gain on the underlying stock. Gain on the put is short-term gain, loss is long-term or short-term depends on the holding period of the underlying stock when the collar transaction was entered. To the extend there is unrecognized gain on the underlying stock, maximum loss is the put premium paid upfront, subject to straddle deferral rule.

TABLE 11
Pros and Cons of a Protective Put Strategy

| Pros | Cons |
|---|---|
| Full protection below the strike of the put. | Purchase of the puts requires a cash |
| Retain full ownership of the concentrated equity position and | outlay. |
| full benefit of future price appreciation. | Affiliates, Insiders, and Control Persons |
| Can monetize the position by borrowing against a percentage | may have to report transactions on Form |
| of the put strike price. | 4. |
| An investor can post the protected value of the position | |
| (stock and put option) as collateral for a loan. The terms of | |
| the loan are flexible and are subject to Regulation T for | |
| purpose loans (for investments in securities). | |

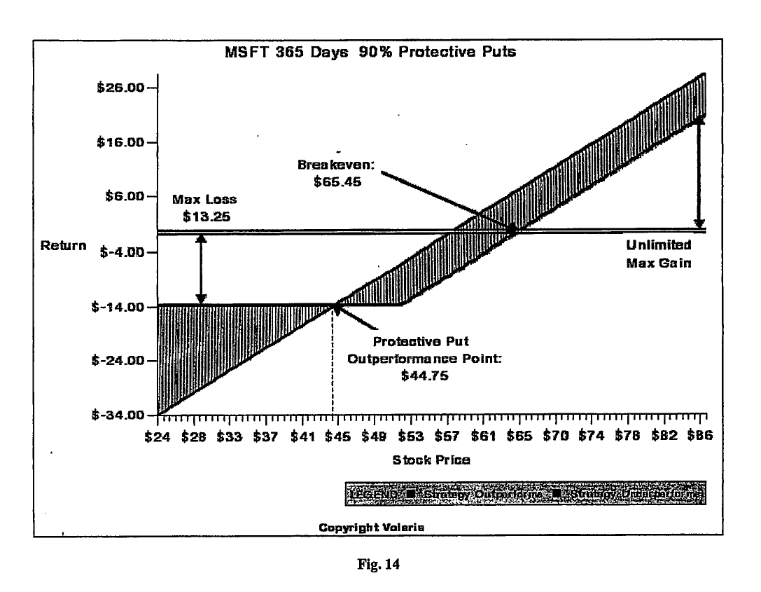

FIG. 14 shows, generally, a graphed output produced by the Nova system based on analysis of a protective put transaction. Many of the key pricing points shown in FIG. 14 are substantially identical to those of FIG. 7 and are not repeated here. Additional price analysis 15 points not shown in FIG. 7 include the following:
Protective Put Outperformance Point. The stock price at which the protective attributes of the collar take effect. Below this price the long stock position is protected.
Breakeven point. The point at which there is no loss or gain for the strategy. In this case, the Breakeven is greater than the Spot due to the fact that Premium is paid to initiate the position.

Additional data items that are used to analyze Protective Put strategy include the following:
Annualized Cost of Insurance. The Annualized Cost of Insurance calculates the cost, as a percentage of spot, of the put (insurance) on an annualized basis. This number gives an idea of how expensive protective puts are to protect a position on an extended basis.
Put Contracts for Delta Neutral Position. Put Contracts for Delta Neutral Position calculates the number of puts (per share) that the client would need to purchased to effect a completely neutral position at the current price and point in time. Long Stock has a Delta of +1, and Long Puts out-of-the-money have a negative delta less than 1, so the product of the deltas of the long puts should equal −1.

Annualized Cost of a Delta Neutral Position. Annualized Cost of a Delta Neutral Position simply takes the cost of the long puts needed to realize a delta neutral position, as a percentage of spot, on an annualized basis.

TABLE 12
Tax Implications for a Protective Put strategy

| Position | | |
|---|---|---|
| Finish | Equity Settlement | Cash Settlement |
| Below | Position value equals to put strike | Capital gain (or loss if stock put strike minus debit |
| Put | minus debit premium paid. | premium paid is greater than cost basis) equals to |
| | Exercise put option, delivery | put strike minus debit premium minus cost basis. |
| | underlying stocks | Capital gain is always short-term, capital loss is |
| | Capital gain (or loss if basis plus debit | long or short-term loss depends on the delivered |
| | premium paid is higher than long put | underlying stocks' holding period at the time long |
| | strike) is put strike minus cost basis | put contract was written. |
| | minus debit premium paid | Capital loss is straddle loss not recognizable |
| | Capital gain is long or short-term gain | currently to the extend there is unrealized gain on |
| | depends on the delivered underlying | the underlying stocks exceeds losses. |
| | stocks' holding period at the time long | Deferred tax (or benefit if cost basis is higher than |
| | put contract was entered. | stock price) is calculated as stock price minus cost |
| | | basis, using long or short-term loss depends on the |
| | | delivered underlying stocks' holding period at the |
| | | time long put contract was written. |
| At or | Position value equals to stock price | Same as Equity Settlement |
| Above | minus debit premium paid. | |
| Put | Put option expires. | |
| | Deferred straddle capital loss equal to | |
| | debit premium paid, and is long or | |
| | short-term loss depending on | |
| | underlying stocks' holding period at | |
| | the time long put contract was written. | |
| | Deferred tax (or benefit if cost basis is | |
| | higher than stock price) is calculated as | |
| | stock price minus cost basis, using | |
| | long or short-term loss depends on the | |
| | delivered underlying stocks' holding | |
| | period at the time long put contract | |
| | was written. | |

### Put Spread

Overview. Put spread is documented and structured as one out-of-money put spread option contract in the over-the-counter (“OTC”) market. Put spread is not entered on the same date of as the individual purchasing the underlying stock, therefore, the “married put” straddle exceptions do not apply. The individual uses cash paid premium when entering the contract. Put spread is an offsetting position of the underlying stock, substantially diminished risk of loss of the stock position, that makes the IRC Section 1092 straddle rules apply, the holding period of the stock terminates when the option contract was entered.

Equity Settlement. The IRC Section 1092 straddle rules have no impact if stock finishes below the long put, the individual always delivery underlying stock against the put. The gain or loss will be taxed at long-term or short-term depends on the holding period of the underlying stock when the put transaction was entered. Individual retains underlying stock, if stock finishes above the spread, because of straddle rules, to the extend there is unrecognized on the underlying stock, net premium paid will create future tax benefit at long-term or short-term depends on the holding period of the underlying stock when the spread transaction was entered.

Cash Settlement. The IRC Section 1092 straddle rules apply if there is loss realized on the spread and there is unrecognized gain on the underlying stock. No current deduction for loss is allowable to the extent of the unrecognized gain on the underlying stock. Gain on the put spread is short-term gain, loss is long-term or short-term depends on the holding period of the underlying stock when the put spread transaction was entered. To the extend there is unrecognized gain on the underlying stock, maximum loss is the net premium paid upfront, subject to straddle deferral rule.

TABLE 13
Pros and Cons

| Pros | Cons |
|---|---|
| Full protection below the strike of the put. | Purchase of the puts requires a cash outlay. |
| Retain full ownership of the concentrated equity position | Affiliates, Insiders, and Control Persons may |
| and full benefit of future price appreciation. | have to report transactions on Form 4. |
| Can monetize the position by borrowing against a | |
| percentage of the put strike price. | |
| An investor can post the protected value of the position | |
| (stock and put option) as collateral for a loan. The terms of | |
| the loan are flexible and are subject to Regulation T for | |
| purpose loans (for investments in securities). | |

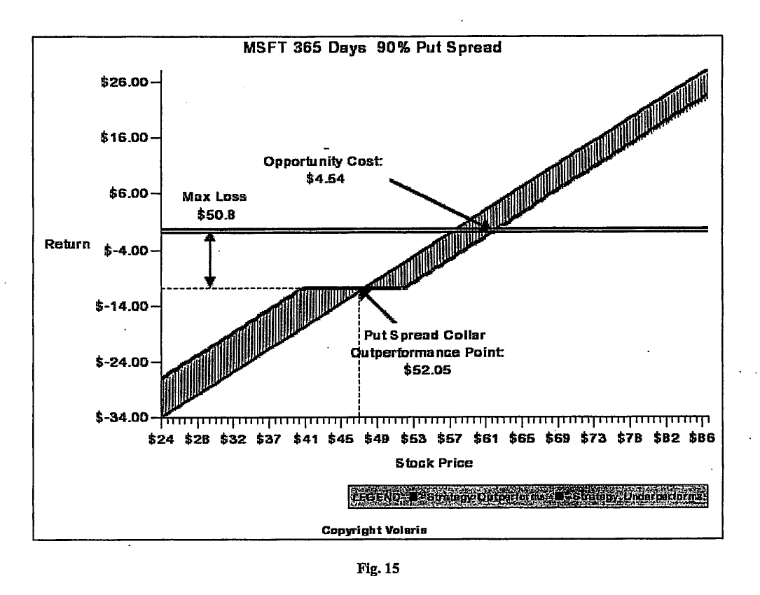

FIG. 15 shows, generally, a graphed output produced by the Nova system based on analysis of a put spread transaction. Many of the key pricing points shown in FIG. 15 are substantially identical to those of FIG. 7 and are not repeated here. Additional price analysis points not shown in FIG. 7 include the following:
Outperformance Point. The stock price at which the protective attributes of the collar take effect. Below this price the long stock position is protected.

Opportunity Cost is equal to the cost of the Put Spread, which is the amount by which the new position will under perform the long stock position without the Put Spread.

TABLE 14
Tax Implications

| Position | | |
|---|---|---|
| Finish | Equity Settlement | Cash Settlement |
| Within | Position value equal to long put | Short-term capital gain equals to long put strike |
| Spread | strike minus debit premium. | minus stock price minus debit premium paid. |
| | Exercise put spread, stock | Long or short-term capital loss will result if the |
| | delivered against long put. | stock price finishes greater than long put strike |
| | Capital gain (or loss if basis plus | minus debit amount depends on the underlying |
| | debit premium paid is higher than | stock holding period when the spread contract was |
| | long put strike) equals long put | entered. |
| | strike minus cost basis minus | Capital loss is a straddle loss not recognizable in |
| | debit premium paid. | the current year to the extend no to exceed |
| | Capital gain is long or short-term | unrecognized gain on the underlying stock. |
| | gain depending on the delivered | Deferred tax (or benefit if cost basis is higher than |
| | underlying stocks' holding period | stock price at the end of put spread contract) |
| | at the time long put contract was | equals to stock price minus cost basis is calculated |
| | entered. | using long or short-term tax rate depends on the |
| | | underlying stocks holding period when the spread |
| | | contract was entered. |

Put Spread Collar

Overview. Put spread collar is documented and structured as one over-the-counter (“OTC”) option contract. Put spread collar is an offsetting position of the underlying stock, substantially diminished risk of loss of the stock position, that makes the IRC Section 1092 straddle rules apply, the holding period of the stock terminates when option collar was entered. No current deduction for losses is allowable to the extent of there is unrecognized gain at the end of the taxable year in “offsetting positions” to the loss position.

Equity Settlement. The IRC Section 1092 straddle rules have no impact on the strategy, because at the end of the collar transaction, if there is gain or loss from the collar transaction, the individual always delivery underlying stock against the collar. The gain or loss will be taxed at long-term or short-term depends on the holding period of the underlying stock when the collar transaction was entered.

Cash Settlement. The IRC Section 1092 straddle rules apply if there is loss realized on the collar and there is unrecognized gain on the underlying stock. No current deduction for loss is allowable to the extent of the unrecognized gain on the underlying stock. Gain on the collar is short-term gain, loss is long-term or short-term depends on the holding period of the underlying stock when the collar transaction was entered. In the case, there is loss realized on the collar, Nova also allows individual to sell stock to generate cash to pay for amount due to the counterparty. The software calculates number of shares needed to sell to generate after tax cash to pay to counterparty.

TABLE 15
Pros and Cons

| Pros | Cons |
|---|---|
| Potential for greater upside appreciation due to the | Client relinquishes upside price appreciation |
| higher strike price of the call when compared to | above call strike and has downside exposure to |
| the call of a Traditional Cashless Collar. | the price level of the put. |
| Sale of the call finances the purchase of the bear | Client must post underlying shares as collateral |
| spread such that no premium is paid by the | to establish the position. |
| investor. | Client typically cannot monetize position by |
| Client has full participation up to the call strike | borrowing against a percentage of the |
| and is protected on the downside to the strike | purchased put strike price. |
| price of the short put. | Careful attention to the constructive sale |
| Collar defers the taxable event that would result | provision of the Taxpayer Relief Act of 1997 is |
| from the sale of shares. | recommended. |
| Client typically retains ownership, dividends, and | Affiliates, Insiders, and Control Persons may |
| voting rights of the underlying equity. | have to report transactions on Form 4. |

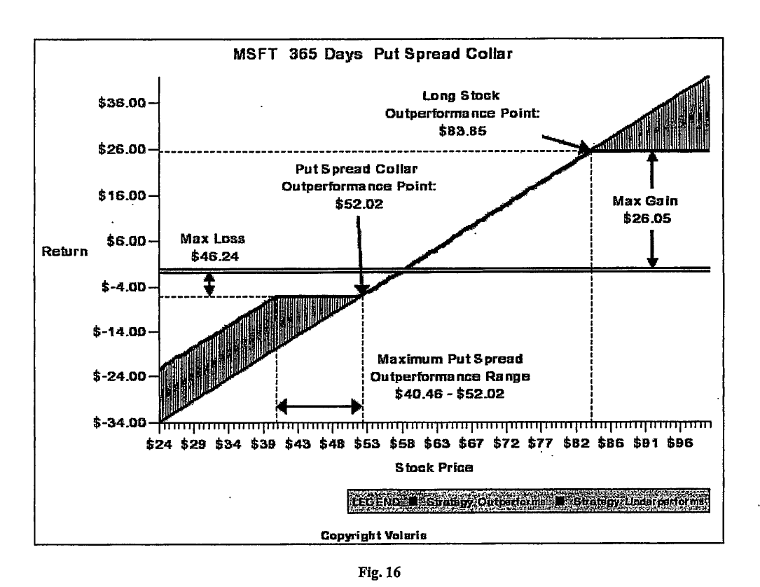

FIG. 16 shows, generally, a graphed output produced by the Nova system based on analysis of a put spread collar transaction. Many of the key pricing points shown in FIG. 16 are substantially identical to those of FIG. 7 and are not repeated here. Additional price analysis points not shown in FIG. 7 include the following:
Outperformance Point. The stock price at which the protective attributes of the collar take effect. Below this price the long stock position is outperformed by the Put Spread Collar. Note that, even though the Put Spread Collar outperforms the Long Stock Position below this point, the total position value will decline below the Short Put Strike.
Max Loss. Details the maximum dollar loss per share that can be sustained by the long stock with the Put Spread Collar strategy in place.

Long Stock Outperformance Point. The stock price at which the short call component of the collar will limit the upside potential of the stock position. Above this price all gains of the long stock position will be foregone.

TABLE 16
Tax Implications

| Position | | |
|---|---|---|
| Finish | Equity Settlement | Cash Settlement |
| Between | Position value equal to long put | Short-term capital gain equal to long put strike |
| Short Put | strike. | minus stock price. |
| and Long | Exercise put spread, stock | Deferred tax (or benefit if cost basis is higher |
| Put | delivered against long put. | than stock price) equals stock price minus cost |
| | Capital gain (or loss if cost basis is | basis |
| | greater than long put strike) equal | Long or short-term tax rate depending on the |
| | to long put strike minus cost basis. | underlying stock holding period when the |
| | Long or short-term depending on | spread contract was entered. |
| | the delivered underlying stock | |
| | holding period when the spread | |
| | contract was entered | |
| Between | Position value equal to stock price. | Same as Equity Settlement. |
| Long Put | Put spread collar expires. | |
| and Short | No change in the underlying | |
| Call | positions. | |
| | Deferred tax (or benefit if cost | |
| | basis is higher than stock price at | |
| | the end of put spread contract) is | |
| | stock price minus cost basis | |
| | Long or short-term tax rate | |
| | depending on the underlying stock | |
| | holding period when the spread | |
| | contract was entered. | |
| Below Short | Position value equal to stock price | Short-term capital gain equals long put strike |
| Put | plus long put strike minus short put | minus short put strike. |
| | strike. | No change in the underlying position. |
| | No change in the underlying | Deferred tax is calculated same as the stock |
| | position. | finishes between long put and short call. |
| | Short-term capital gain equal to | |
| | long put strike minus short put | |
| | strike. | |
| | Deferred tax is calculated same as | |
| | the stock finishes between long put | |
| | and short call. | |
| Above Short | Position value equals to short call | Deferred straddle loss equals stock price minus |
| Call | strike. | short call strike. |
| | Stock gets assigned, delivered | Model will calculate # of shares to sell to |
| | against short call. | generate after tax cash to pay to the |
| | Capital gain (or loss if cost basis is | counterparty. |
| | greater than short call strike) equals | Model will not offset capital gain, if any, from |
| | to short call strike minus cost basis. | the sale of underlying position with straddle |
| | Long or short-term tax rate | losses created by the option, to the extent there |
| | depending on the holding period of | is remaining underlying stock and total loss is |
| | the underlying position when the | not exceeding unrecognized gain. |
| | put spread collar contract was | Deferred tax on the remaining shares equal to |
| | entered. | stock price minus cost basis,. |
| | | Long or short-term tax rate depending on the |
| | | underlying stock holding period when the |
| | | spread contract was entered. |

In addition to the protection strategies, discussed above, the system also supports yield enhancing strategies as described below. These strategies are described in summary form in Table 17 and in detailed form thereafter.

TABLE 17
Comparison of Yield enhancement strategies

| | Purpose | | | |
|---|---|---|---|---|
| | Yield | | | |
| Strategy | Enhancement | Other | Trade Structure | General Characteristics |
| Bearish | Yes | | 1. Buy Put | Client establishes the butterfly |
| Butterfly | | | 2. Sell Put | spread by purchasing a vertical |
| | | | 3. Buy Put | spread and selling a vertical |
| | | | 4. Optional Sell | spread |
| | | | Put | Net Spread Position - all |
| | | | | options will have the same |
| | | | | expiration date |
| | | | | Financed by selling an out-of- |
| | | | | the-money call option |
| | | | | Structured to eliminate need to |
| | | | | pay option premium |
| Bullish | Yes | | 1. Buy Call | Client establishes the butterfly |
| Butterfly | | | 2. Sell Call | spread by purchasing a vertical |
| | | | 3. Buy Call | spread and selling a vertical |
| | | | 4. Optional Sell | spread |
| | | | Put | Net Spread Position - all |
| | | | | options will have the same |
| | | | | expiration date |
| | | | | Financed by selling an out-of- |
| | | | | the-money call option |
| | | | | Structured to eliminate need to |
| | | | | pay option premium |
| Call Write | Yes | Small Cushion | 1. Sell OTM | Client compensated for |
| | | against Downside | Calls | willingness to forego stock |
| | | Movement | | appreciation above call strike |
| | | | | price |

### Bearish Butterfly

Overview. Bearish Butterfly is combination of four put (4) contracts and one (1) call contract at four (4) different points traded on listed markets. The short call is an out-the-money qualified cover call contract, credit premium received from short call offset with debit premium paid for bear butterfly, net premium is zero. There are three possible straddles embedded in the trade.
First, short call and butterfly is a straddle, but because we assume these trades always come off together, there should not be any deferral straddle losses.
Second, butterfly and underlying stock is a potential straddle, but because we assume there is no substantial diminishing of risk, therefore, section 1092 straddle rules do not apply.
Third, short call (4) and underlying is potential straddle, but because short call are always out-of-money call meets the qualified cover call exception, therefore the straddle rules do not apply.

Lastly, because the underlying stock is not part of straddle, therefore it's holding period continues throughout the trade. However, Nova software treats the underlying it treats the underlying stock's holding period suspended when bullish butterfly was entered.

TABLE 18
Pros and Cons

| Pros | Cons |
|---|---|
| Can be structured for profit of a down | Will have an opportunity cost beyond the level of the |
| movement in the underlying stock position. | call strike if the if the stock runs beyond the strike of |
| Can be purchased and financed with an out-of- | the financing short call. |
| the-money call option | Affiliates should consult legal counsel and pay |
| Can be structured with no premium using | particular attention to short swing profits and profit |
| asymmetrical strike prices. | disgorgement rules. |
| Spread will outperform net long stock | |
| ownership if the stock closes between a | |
| predefined range. | |
| No opportunity cost if the stock closes below | |
| the financing short call. | |
| Can utilize high implied volatility to create | |
| attractive spreading opportunities. | |
| Investor retains all stock ownership rights. | |

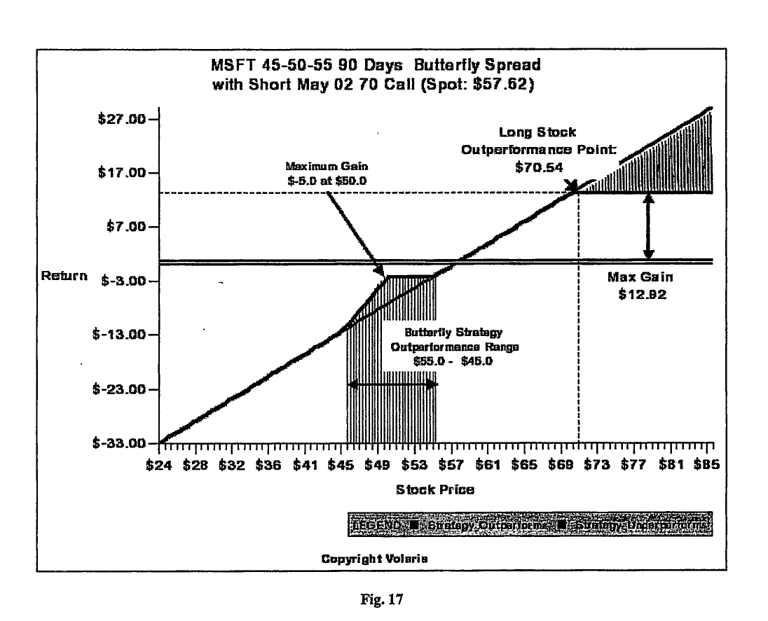

FIG. 17 shows, generally, a graphed output produced by the Nova system based on analysis of a bearish butterfly transaction. Many of the key pricing points shown in FIG. 17 are substantially identical to those of FIG. 7 and are not repeated here. Additional price analysis points not shown in FIG. 7 include the following:
Butterfly Strategy Outperformance Range is the price range at which the Butterfly will add the yield enhancement effect on top of the underlying position.

Long Stock Outperformance Point is the stock price at which the short call component of the financed butterfly will limit the upside potential of the stock position. Above this price all gains of the long stock position will be foregone.

TABLE 19
Tax Implications

| Position Finish | Equity Settlement | Cash Settlement |
|---|---|---|
| Above Near | Nova does not | Premium on calls and butterfly offset each other |
| Wing Strike and | provide for Equity | No change in the underlying positions. |
| Below Financing | Settlement of | No taxable event. |
| Call | Butterfly Spreads. | Deferred tax (benefit if cost basis is higher than stock |
| | | price) is calculated as stock price minus cost basis, |
| | | using long or short-term tax rate depends on the |
| | | underlying stock holding period until bullish butterfly |
| | | transactions is closed. |
| Between Near | Nova does not | Premium received from short call (4) and premium |
| Wing and Body | provide for Equity | paid for bull butterfly offset each other. |
| | Settlement of | No change in the underlying positions. |
| | Butterfly Spreads. | Short-term capital gain generated from stock price |
| | | minus long call strike (1). |
| | | Deferred tax (benefit if cost basis is higher than stock |
| | | price) is calculated as stock price minus cost basis, |
| | | using long or short-term tax rate depends on the |
| | | underlying stock holding period until bullish butterfly |
| | | transaction is closed. |
| Between Body and | Nova does not | Premium received from short call (4) and premium |
| Far Wing | provide for Equity | paid for bull butterfly offset each other. |
| | Settlement of | No change in the underlying positions. |
| | Butterfly Spreads. | Short-term capital gain equal to stock price minus long |
| | | call strike (1) minus 2 times the stock price - short call |
| | | strike (2). |
| | | Deferred tax (benefit if cost basis is higher than stock |
| | | price) is calculated as stock price minus cost basis, |
| | | using long or short-term tax rate depends on the |
| | | underlying stock holding period until bullish butterfly |
| | | transaction is closed. |
| Below Far Wing | Nova does not | Premium on calls and butterfly offset each other |
| | provide for Equity | No change in the underlying positions. |
| | Settlement of | No taxable event. |
| | Butterfly Spreads. | Deferred tax (benefit if cost basis is higher than stock |
| | | price) is calculated as stock price minus cost basis, |
| | | using long or short-term tax rate depends on the |
| | | underlying stock holding period until bullish butterfly |
| | | transaction is close |
| Above Financial | Nova does not | Two long calls (1) (3) and two short calls (2), premium |
| Call | provide for Equity | received and paid all offset each other. |
| | Settlement of | Short-term capital loss resulted from stock price minus |
| | Butterfly Spreads. | short call strike (4). |
| | | Capital loss is always short-term because short calls do |
| | | not create holding period. |
| | | If underlying shares have long term holding period, it |
| | | is inefficient to use long-term gain to offset short-term |
| | | loss. |
| | | Deferred tax (benefit if cost basis is higher than stock |
| | | price) is equals stock price minus cost basis, using long |
| | | or short-term tax rate depends on the underlying stock |
| | | holding period until bullish butterfly transaction is |
| | | closed. |

### Bullish Butterfly

Overview. Bullish Butterfly is combination of five (5) call contracts at four (4) different points traded on listed markets, and equity settled. The short calls are out-the-money qualified cover call contracts, credit premium received from short call offset with debit premium paid for bull butterfly, net premium is zero. There are three possible straddles embedded in the trade.
First, short call and butterfly is a straddle, but because we assume these trades always come off together, there should not be any deferral straddle losses.
Second, butterfly and underlying stock is a potential straddle, but because we assume there is no substantial diminishing of risk, therefore, section 1092 straddle rules do not apply.
Third, short call and underlying is potential straddle, but because short call are always out-of-money call meets the qualified cover call exception, therefore the straddle rules do not apply.

Lastly, because the underlying stock is not part of straddle, therefore it's holding period continues throughout the trade. However, Nova software treats the underlying it treats the underlying stock's holding period suspended when bullish butterfly was entered.

TABLE 20
Pros and Cons

| Pros | Cons |
|---|---|
| Can be structured for profit of an up | Will have an opportunity cost beyond the level of the |
| movement in the underlying stock position. | call strike if the stock runs beyond the strike of the |
| Can be purchased and financed with an out-of- | financing short call. |
| the-money call option | Affiliates should consult legal counsel and pay |
| Can be structured with no premium using | particular attention to short swing profits and profit |
| asymmetrical strike prices. | disgorgement rules. |
| Spread will outperform net long stock | |
| ownership if the stock closes between a | |
| predefined range. | |
| Will not have an opportunity cost if the stock | |
| closes below the financing short call. | |
| Can utilize high implied volatility to create | |
| attractive spreading opportunities. | |
| Investor retains all stock ownership rights. | |

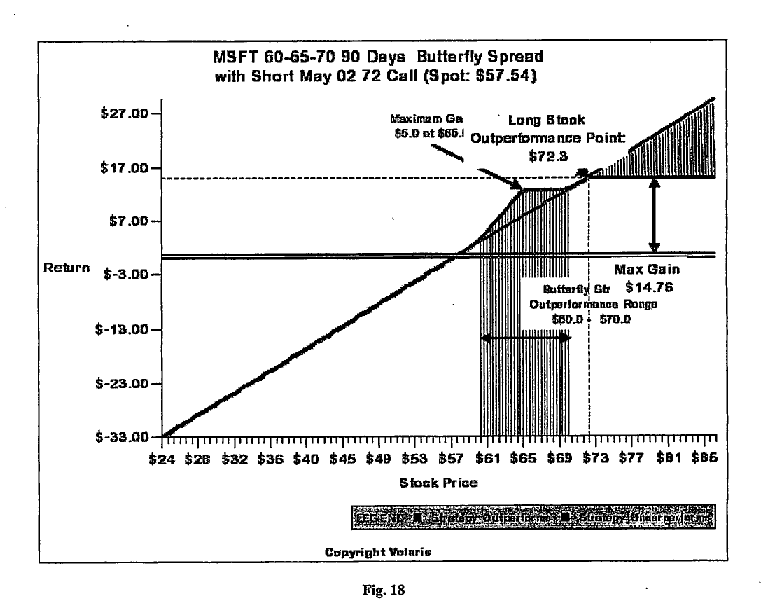

FIG. 18 shows, generally, a graphed output produced by the Nova system based on analysis of a bullish butterfly transaction. Many of the key pricing points shown in FIG. 18 are substantially identical to those of FIG. 7 and are not repeated here. Additional price analysis points not shown in FIG. 7 include the following:
Out performance Range. The price range at which the Butterfly will add the yield enhancement effect on top of the underlying position.

Long Stock Outperformance Point. The stock price at which the short call component of the financed butterfly will limit the upside potential of the stock position. Above this price all gains of the long stock position will be foregone.

TABLE 21
Tax Implications

| Position Finish | Equity Settlement | Cash Settlement |
|---|---|---|
| Below Near | Nova does not | Premium on calls and butterfly |
| Wing Strike | provide for Equity | offset each other |
| | Settlement of | No change in the underlying |
| | Butterfly Spreads. | positions. |
| | | No taxable event. |
| | | Deferred tax (benefit if cost basis |
| | | is higher than stock price) is |
| | | calculated as stock price minus |
| | | cost basis, using long or short-term |
| | | tax rate depends on the underlying |
| | | stock holding period until bullish |
| | | butterfly transactions is closed. |
| Between Near | Nova does not | Premium received from short call |
| Wing and Body | provide for Equity | (4) and premium paid for bull |
| | Settlement of | butterfly offset each other. |
| | Butterfly Spreads. | Short-term capital gain generated |
| | | from stock price minus long call |
| | | strike (1). |
| | | No change in the underlying |
| | | positions. |
| | | Deferred tax (benefit if cost basis |
| | | is higher than stock price) is |
| | | calculated as stock price minus |
| | | cost basis, using long or short-term |
| | | tax rate depends on the underlying |
| | | stock holding period until bullish |
| | | butterfly transaction is closed. |
| Between Body | Nova does not | Premium received from short call |
| and Far Wing | provide for Equity | (4) and premium paid for bull |
| | Settlement of | butterfly offset each other. |
| | Butterfly Spreads. | Short-term capital gain equal to |
| | | stock price minus long call strike |
| | | (1) minus 2 times the stock price - |
| | | short call strike (2). |
| | | No change in the underlying |
| | | positions. |
| | | Deferred tax (benefit of cost basis |
| | | is higher than stock price) is |
| | | calculated as stock price minus |
| | | cost basis, using long or short-term |
| | | tax rate depends on the underlying |
| | | stock holding period until bullish |
| | | butterfly transaction is closed. |
| Between Far | Nova does not | Premium on calls and butterfly |
| Wing and | provide for Equity | each other. |
| Financial Call | Settlement of | No taxable event. |
| | Butterfly Spreads. | No change in the underlying |
| | | positions. |
| | | Deferred tax (benefit if cost basis |
| | | is higher than stock price) is |
| | | calculated as stock price minus |
| | | cost basis, using long or short-term |
| | | tax rate depends on the underlying |
| | | stock holding period until bullish |
| | | butterfly transaction is close |
| Above | Nova does not | Two long calls (1) (3) and two |
| Financial Call | provide for Equity, | short calls (2), premium received |
| | Settlement of | and paid all offset each other. |
| | Butterfly Spreads | Short-term capital loss resulted |
| | | from stock price minus short call |
| | | strike (4). |
| | | Capital loss is always short-term, |
| | | because short calls do not create |
| | | holding period. |
| | | If underlying shares have long term |
| | | holding period, it is inefficient to |
| | | use long-term gain to offset |
| | | short-term loss. |
| | | Deferred tax (benefit if cost basis |
| | | is higher than stock price) is |
| | | equals stock price minus cost basis, |
| | | using long or short-term tax rate |
| | | depends on the underlying stock |
| | | holding period until bullish |
| | | butterfly transaction is closed. |

### Call Write

Overview. Nova software assumes writing calls on equity settled listed market that has strike price at or out-of-money or in-the-money that is one strike below previous day's closing stock price. For stock closed at $25 or less, the only in-the-money call strikes Nova write has 85% or more of the previous day's closing price. Credit premium is collect at the time the options are written. All the call writes meet the qualified cover call rules, therefore Section 1092 straddle rules do not apply. The holding period of the underlying stock continues if at or out-of-money was written on it, the holding period of the underlying stock suspended during the call written period, if in-the-money call was written. However, Nova software does not differentiate in-the-money call from out-of-money in calculating holding period, it treats the underlying stock's holding period suspended when call was written.

If the stock finishes above the call strike, the individual always delivery underlying stock against the call. The gain or loss will be taxed at long-term or short-term depends on the holding period of the underlying stock when the call transaction was entered. Individual retains underlying stock, if stock finishes at or below the call strike, net premium collected is short-term gain regardless of the holding period of the underlying stock.

TABLE 22
Pros and Cons

| Pros | Cons |
|---|---|
| Receipt of up-front premium | Investor foregoes upside price |
| enhances yield. | appreciation above call strike price |
| | during the term of the option. |
| Each call write is short term in | Investor remains exposed to the |
| nature, allowing for multiple writes | downside risk of stock ownership |
| per year, thereby enhancing yield | beyond the premium received. |
| considerably. | |
| Up-front premium provides limited | Investor must post underlying shares |
| downside protection against a | or margin as collateral. |
| decline in the price of the stock. | |
| Cash-settled option may allow | Affiliates and insiders should consult |
| investor to defer taxable event | legal counsel and pay particular |
| on sale of stock. | attention to short swing profits and |
| | profit disgorgement rules. |

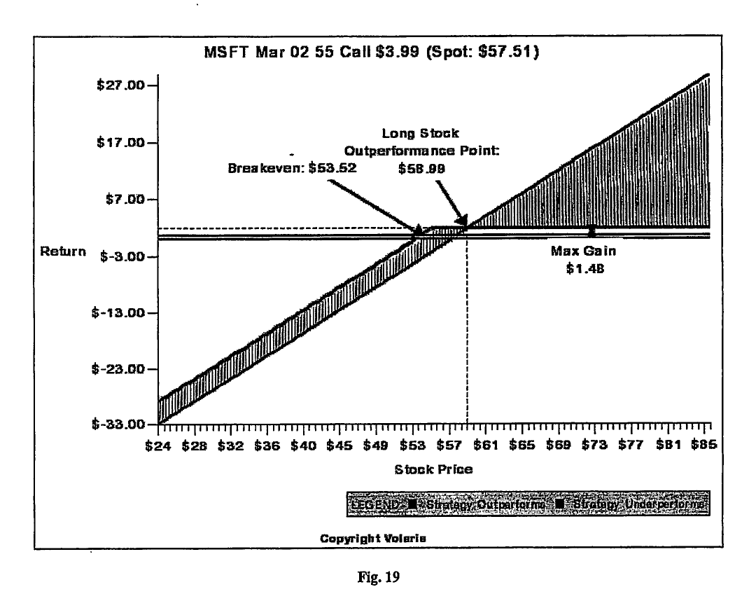

FIG. 19 shows, generally, a graphed output produced by the Nova system based on analysis of a call write transaction. Many of the key pricing points shown in FIG. 19 are substantially identical to those of FIG. 7 and are not repeated here. Additional price analysis points not shown in FIG. 7 include the following:

Breakeven details the point at which the position has no gain or loss. In the case of the Call Write, the Breakeven is less than the Spot by the amount of the premium received per share.

TABLE 23
Tax Implications

| Position Finish | Equity Settlement | Cash Settlement |
|---|---|---|
| Below Call | Qualified Covered Call contract | Nova does not |
| Strike | expired. | provide for Cash |
| | Capital gain generated from credit | Settlement of |
| | premium, is always short-term gain. | Call Writes. |
| | Deferred tax (or benefit if cost basis | |
| | is higher than stock price) on the | |
| | underlying position that has at or | |
| | out-of-money calls written equals | |
| | to stock price minus cost basis | |
| | calculated using long or short-term | |
| | tax rate depends on the holding | |
| | period of stock from original | |
| | purchase date until call option lapsed. | |
| | Deferred tax on underlying position | |
| | that has in-the-money call written | |
| | equals to stock price minus cost basis | |
| | calculated using long or short-term | |
| | tax rate depends on the holding | |
| | period of stock from original | |
| | purchase date to the date the call was | |
| | written. | |
| Above Call | Stocks get assigned. | Nova does not |
| Strike | Capital gain (or loss if cost basis is | provide for Cash |
| | higher than call strike plus credit | Settlement of Call |
| | premium) is call strike plus credit | Writes. |
| | premium minus cost basis | |
| | Capital gain is long or short-term | |
| | depending on the holding period of | |
| | the underlying stocks' at the time | |
| | call options got assigned for stock | |
| | had at or out-of-money calls written. | |
| | For stock with first in-the-money | |
| | calls written, the holding period | |
| | suspended when options were | |
| | written. | |

The Nova system may also include probability analyzers to analyze investment outcomes. The probability analyzers can use the Black-Scholes Option Pricing Model and Monte Carlo simulations to provide statistical likelihood that a stock price will be above or below certain predefined levels in the future. Use of two particular analyzers—the Probability Calculator and the Probability Simulator, is described herein. Implementations may also use other analyzers.

The Probability Calculator

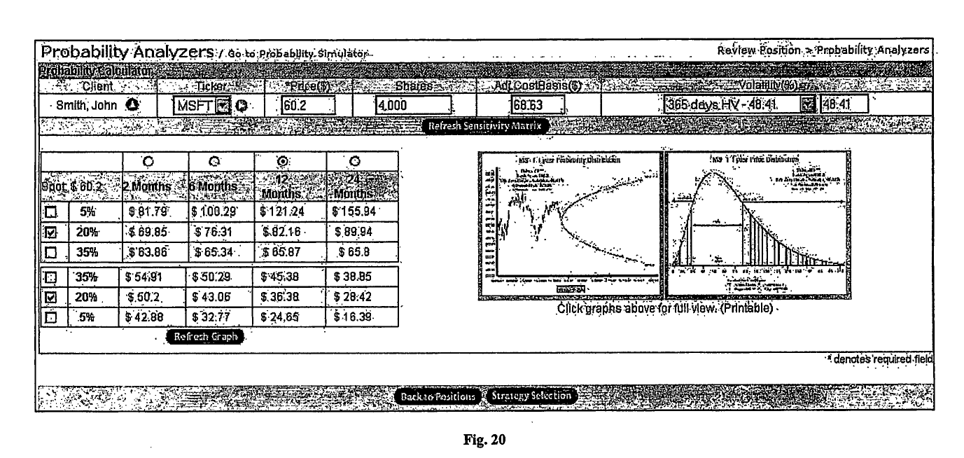

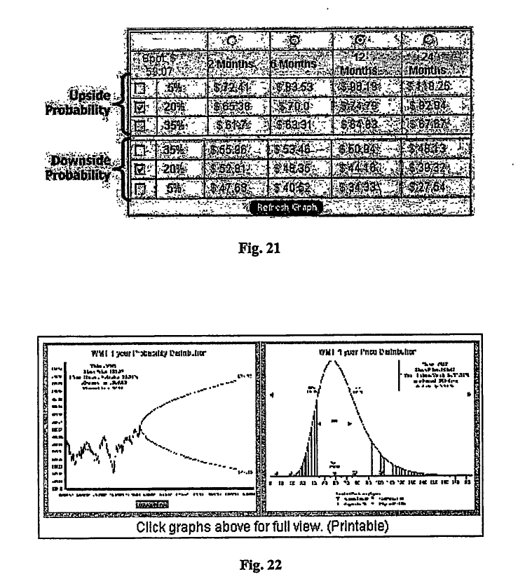

The following steps are followed to apply the Probability Calculator to a client's position.
1. The probability calculator is initiated by selecting an on-screen GUI button “Analyze”. Upon selection of the “Analyze” function, a Probability Calculator screen, such as that shown in FIG. 20, is displayed. If a client has multiple positions in a particular stock, the Shares value equals all shares held. Price and Adjusted Cost Basis data are calculated on a weighted basis.
2. The user then selects an appropriate Volatility (%) from the drop-down list. The volatilities available from the drop-down list can be based upon a position's historic values or a user-defined volatility.
3. The user can then select a “refresh” function to update the sensitivity matrix shown in FIG. 20 and FIG. 21with the corresponding values.
4. The user then selects the appropriate timeframe (e.g., 2, 6, 12, or 24 months) from the sensitivity matrix (FIG. 20 and FIG. 21).
5. The user then checks the upside or downside probability level(s) in the Sensitivity Matrix to be included in the graphs shown at the right of FIG. 20 and shown in detail in FIG. 22.
6. The user may then select a Refresh Graph function to update the graphs of FIG. 20/FIG. 22 based on the new selections. The default probability setting is 12 months at 20%. When an upside or downside probability percentage is checked, the corresponding checkbox on the other side (i.e., downside, upside) is checked automatically.
7. The user may then display the Probability Distribution or Price Distribution graphs (FIG. 22) by clicking on the appropriate thumbnail.

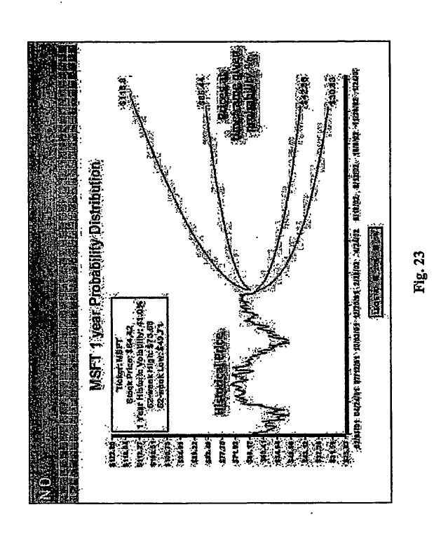

The Probability Distribution graph (FIG. 23) displays a stock or index price history for one year (252 trading days) and one, two, or three iso-probability lines that relate to future stock or index prices for a given volatility, probability and selected time period. The “megaphone” lines represent the data generated in the Sensitivity Matrix for the position. FIG. 23 highlights the major component of the graph using a 1 year price distribution with a 5% and 20% probability. When the iso-probability lines 12 months into the future are displayed, the lines can be used to extrapolate the price associated with that same volatility and probability for any time period along that same line For example: follow the 12 month line out only three months, the price at that level is relative to the same probability and volatility.

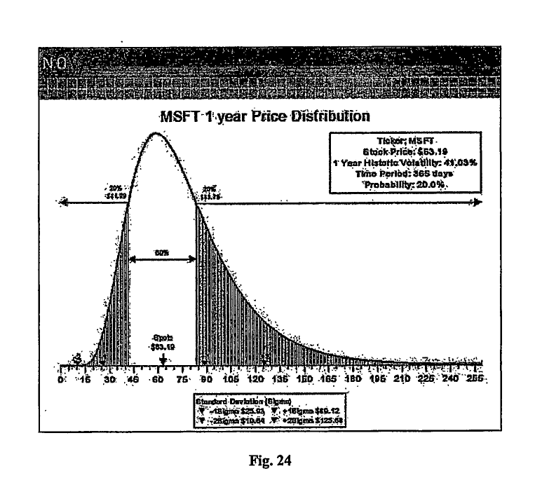

The Price Distribution graph (FIG. 24) displays a position's current price and the probability of the position's price moving within a specified range. The FIG. 24 graph shows a 1 year price distribution with a 20% probability. The Price Distribution graph is a standard log-normal distribution of a stock or index's price (a variation on the normal “bell” curve). Because a stock's price can go no lower than zero but theoretically as high as infinity, the curve is skewed as such. The area under the curve represents 100% of the possible outcomes of the stock or index price movement. Using a probability density function for a given price, probability, volatility, and future time period, the corresponding percentage of the area under the curve is shaded. For example: for a 20% probability, 20% of the area under the curve is shaded on the left and 20% of the area under the curve is shaded on the right. Since a stock price can go up or down, there are two prices associated with each probability percentage—one above the current price and one below the current price. The Spot, +1, and +2 standard deviations are detailed on the x-axis for reference points relating to the probability.

Probability Simulator

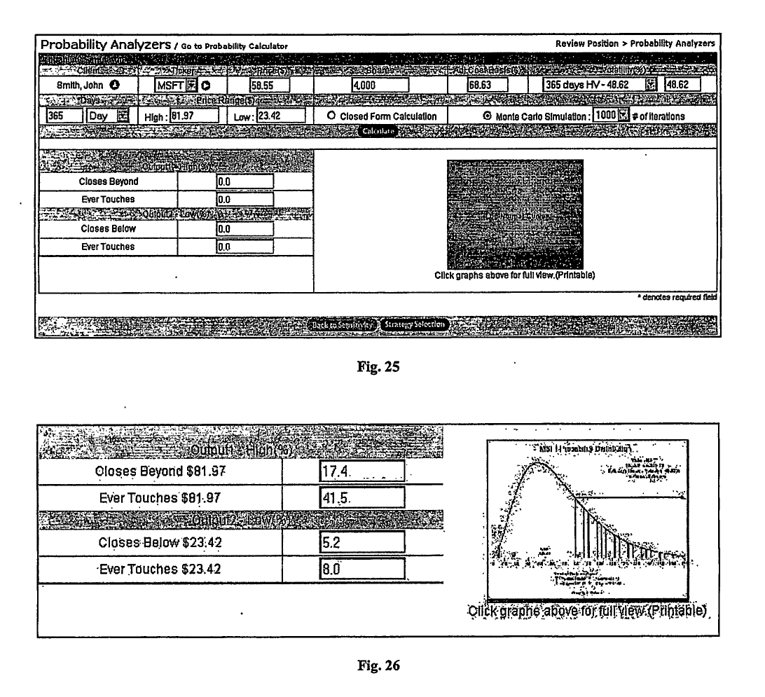

The Probability Simulator is another type of analyzer that may be used. The following steps are followed to apply the Probability Simulator to a client's position.
1. The Probability Simulator is initiated by selecting an on-screen link (e.g., “Go to Probability Simulator” link). Upon selection, a probability analyzer screen, such as that shown in FIG. 25 is displayed. If a client has multiple positions in a particular stock, the Shares equals all shares held. Price and Adjusted Cost Basis data are calculated on a weighted basis.
2. The user then selects an appropriate Volatility (%) from, e.g., a drop-down list. The volatilities available from the drop-down list are based upon the position's historic values or a user-defined volatility. The user also selects a desired time period measurement (Day, Month, or Year) and enters a value defining the time period.
5. The user may then adjust High and Low Price Range ($) values as needed.
6. The user can then select from a number of different calculation types. For example, a “Closed Form Calculation” or a “Monte Carlo Simulation” may be selected along with a number of iterations, where appropriate.
7. The user then selects a calculate function resulting in an update to output values and to the log normal graph (see FIG. 26).
8. The Probability Distribution graph may then be displayed by clicking the thumbnail shown in the right-hand side of FIG. 26. Descriptions of each graph follows.

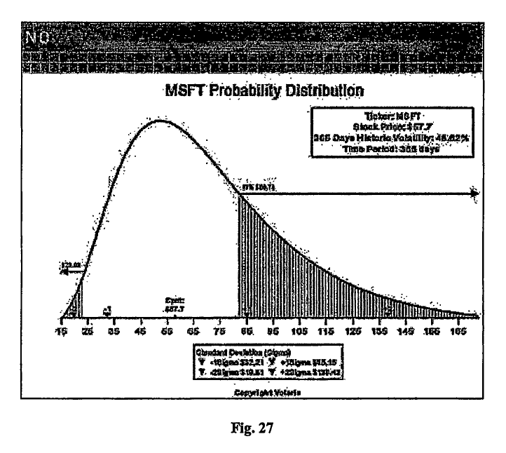

The Probability Distribution graph (FIG. 27) displays a position's current price and the probability of the position's price moving within a specified range. The sample graph in FIG. 27 shows a 1 year price distribution with a 18% probability. The Probability Distribution graph is a standard log-normal distribution of a stock or index's price (a variation on the normal “bell” curve). Because a stock's price can go no lower than zero but theoretically as high as infinity, the curve is skewed as such. The area under the curve represents 100% of the possible outcomes of the stock or index price movement. Using a probability density function for a given price, probability, volatility, and future time period, the corresponding percentage of the area under the curve is shaded. For example: for 18% probability, 18% of the area under the curve is shaded on the left and 18% of the area under the curve is shaded on the right. Since a stock price can go up or down, there are two prices associated with each probability percentage—one above the current price and one below the current price. The Spot, ±1, and ±2 standard deviations are detailed on the x-axis for reference points relating to the probability.

In some implementations, the Probability Calculator may be sued for a theoretical analysis. That is, to analyze a “theoretical” portfolio consisting of a user-defined set of securities, rather than the user's actual portfolio.

The invention may be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output. The invention may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

A number of embodiments of the present invention have been described. Nevertheless, it will be understood that various modifications may be made without departing from the spirit and scope of the invention. Accordingly, other embodiments are within the scope of the following claims.

What is claimed is:

1. A computer-implemented method for managing an investment portfolio, the method comprising:
at an application server remotely accessible by a web browser,
storing investor portfolio data at the server, the portfolio data comprising data identifying assets owned by an investor and tax status information associated with the investor;
computing a hedging strategy based on a portfolio analysis comprising an analysis of at least a first one of the assets identified by the investor portfolio data, wherein:
computing said hedging strategy comprises determining at least a first hedging transaction, and
the portfolio analysis further comprises a tax impact analysis to determine gain and loss and tax impact data associated with the first hedging transaction, said determined gain, loss and tax impact data being determined based on the investor's particular tax status information; and
presenting hedging strategy and tax impact information particularized to the investor.

2. The method of claim 1 wherein said first hedging strategy is determined based on risk preferences associated with the investor.

3. The method of claim 2 wherein risk preferences comprises data enabling automate selection from among a plurality of hedging strategies having different risk profiles, said strategies comprising protective and yield enhancing strategies.

4. The method of claim 2 wherein said first hedging strategy is further determined based on market data associated with the assets identified in the investor portfolio data, the market data comprising pricing and volatility data.

5. The method of claim 4 wherein the market data comprises current and historical data.

6. The method of claim 1 wherein:
said portfolio analysis comprises, for each of a plurality of price probabilities associated with an asset, computing a position value, a realized gain/loss, an unrealized gain/loss, current taxes, future taxes, net position value, shares to sell for settlement, net shares, and an unused realized loss.

7. The method of claim 6 wherein said portfolio analysis further comprises applying a tax straddle rule and constructive sales rules compliant with the Taxpayer Relief Act of 1997.

8. The method of claim 1 wherein tax status information further comprises total income information, and tax impact analysis comprises determining a tax rate applicable to the first hedging transaction.

9. The method of claim 1 wherein computing the first hedging strategy comprises strategies based on a user-specified timeframe and user specified upside and downside probabilities that an asset price will be a predetermined price at a predetermined time.

10. The method of claim 1 wherein said portfolio analysis comprises predicting asset price movement using a Monte Carlo simulation.

11. The method of claim 1 wherein presenting the hedging strategy and tax impact information comprising presenting a result of the analysis using a graph, the graph comprising:
a long stock position showing return of an investment in an asset versus price of the asset;
a option strategy overlay, the option strategy overlay comprising a gain area plotted using a first display characteristic and a loss area plotted using a second display characteristic; and
an outperformance range comprising an option strategy outperformance range and a long stock outperformance range;

12. The method of claim 1 wherein:
the analysis further comprises analysis of a second one of the assets; and
displaying the hedging strategy comprises presenting a comparative display of the analysis of assets.

13. The method of claim 1 further comprising computing a probability analysis modeling whether asset values will be above a first predefined level or below a second predefined level at a future time.

14. The method of claim 1 further comprising determining a recommended asset sale/purchase strategy based on a risk preference associated with the investor.

15. A computer-implemented method for managing an investment portfolio, the method comprising:
at an application server remotely accessible by a web browser,
storing investor portfolio data comprising data identifying assets owned by an investor and tax status information associated with the investor;
computing a hedging strategy based on analysis of at least a first one of the assets identified by the investor portfolio data, said analysis being based on at least (i) the tax status information and risk preferences associated with the investor, and (ii) market data associated with the first asset, the market data comprising pricing and volatility data, and said hedging strategy comprising at least a first hedging transaction;
displaying the hedging strategy comprising displaying tax impact information associated with the first hedging transaction;
wherein the tax analysis comprises analysis of option sale and option plus stock sale strategies and calculation of federal and local income taxes associated with the option sale and option plus stock sale strategies.

16. The method of claim 15 wherein said tax analysis further comprises, for each of a plurality of price probabilities associated with an asset, computing a position value, a realized gain/loss, an unrealized gain/loss, current taxes, future taxes, net position value, and shares to sell for settlement.

17. A computer system for managing an investment portfolio, the system comprising:
a database storing investor portfolio data, the portfolio data comprising data identifying assets owned by an investor and tax status information associated with the investor;
a processor coupled to the database, the processor comprising stored instructions enabling computation of a hedging strategy based on a portfolio analysis including an analysis of at least a first one of the assets identified by the investor portfolio data,
wherein:
the stored instructions to compute said hedging strategy comprise instructions to determine at least a first hedging transaction, and
the stored instructions to compute the portfolio analysis further comprises instructions to compute a tax impact analysis and determine gain, loss and tax impact data associated with the first hedging transaction, said determined gain, loss and tax impact data being determined based on the investor's particular tax status information, and
the stored instructions further comprise instructions to present hedging strategy and tax impact information particularized to the investor.
